(19) United States
(12) Patent Application Publication
(10) Pub. No.: US 2026/0147783 A1
(43) Pub. Date: May 28, 2026

(54) CONDITIONAL ATTRIBUTES

(71) Applicant: Reltio, Inc., Redwood Shores, CA (US)

(72) Inventors: Abhradeep Sengupta, Bengaluru (IN); Anshuman Kanwar, Cambridge, MA (US)

(21) Appl. No.: 19/396,259

(22) Filed: Nov. 20, 2025

Related U.S. Application Data
(60) Provisional application No. 63/724,270, filed on Nov. 22, 2024.
(60) Provisional application No. 63/758,282, filed on Feb. 13, 2025.

(51) Int. Cl. G06F 16/26

(52) U.S. Cl. CPC G06F 16/26

(57) ABSTRACT

Ingesting data from one or more data sources, wherein the data is associated with a tenant of a multi-tenant platform. Generating a machine learning model input based on the ingested data. Providing the generated machine learning model input to a machine learning model. Inferring, using the machine learning model, an inferred dynamic data structure, wherein the inferred dynamic data structure includes a subset of entity attributes inferred by the machine learning model from a set of the entity attributes, wherein at least a portion of the entity attributes include conditional entity attributes, wherein the conditional entity attributes depend on the values of one or more of the other entity attributes of the set of the entity attributes. Presenting, via a graphical user interface (GUI), a visual representation of the inferred dynamic data structure. Tracking user interactions received through the GUI associated with the visual representation of the inferred dynamic data structure. Dynamically adjusting, using one or more other machine learning models, the inferred dynamic data structure based on the tracked user interactions. Presenting, via the GUI, the dynamically adjusted inferred dynamic data structure.

### CROSS-REFERENCE TO RELATED APPLICATIONS

The present application claims priority to U.S. Provisional Patent Application Ser. No. 63/758,282 filed Feb. 13, 2025 and entitled “Conditional Attributes,” and to U.S. Provisional Patent Application Ser. No. 63/724,270 filed Nov. 22, 2024 and entitled “Connected Data Platform,” each of which is incorporated by reference herein.

### BRIEF DESCRIPTION OF THE DRAWINGS

FIG. 1 depicts a diagram of an example connected data platform.

FIG. 2 depicts a diagram of an example environment for an integration hub system.

FIG. 3 depicts a diagram of an example three-layer model.

FIG. 4 depicts a diagram of some examples of entity type, relationship type and event metadata.

FIG. 5 depicts a flowchart of an example of a method of dynamic matching facilitation.

FIG. 6 depicts a diagram of an example automated data classification system.

FIG. 7 depicts a flowchart of an example method of automated data classification.

FIG. 8 depicts a flowchart of an example method of automated data classification.

FIG. 9 depicts a dynamic matching facilitation flowchart.

FIG. 10 depicts a dynamic matching flowchart.

FIG. 11 depicts a high-level flowchart for MatchIQ.

FIG. 12 depicts a flowchart for configuring survivorship within an example User Interface (UI).

FIG. 13 depicts a flowchart of an example of a method of cross-tenant matching and lineage EID promotion.

FIG. 14 depicts a diagram of an example of a conditional attribute system.

FIG. 15 depicts a flowchart of an example method of inferring dynamic data structures (or, data models) and generating graphical user interfaces (GUIs) based on the inferred dynamic data structures.

FIG. 16 depicts a flowchart of an example method of defining a data model (or, data structure) based on deterministic conditional attribute rules, and generating a response to a query based on the data model.

FIG. 17 depicts a flowchart of an example method of defining a data model (or, data structure) based on deterministic conditional attribute rules and an order of entity attributes and associated values.

FIG. 18 depicts a flowchart of an example method of using dynamic data structure (or, data model) inference and automated data classification to resolve a query.

### DETAILED DESCRIPTION

A claimed solution rooted in computer technology overcomes problems specifically arising in the realm of computer technology. In various embodiments, a computing system ingests data from one or more data sources. The data may belong to a tenant of a multi-tenant platform. The computing system can generate or select a machine learning model input based on the ingested data. The computing system can provide the generated machine learning model input to a machine learning model to infer a dynamic data structure. The inferred dynamic data structure can include a subset of entity attributes that are inferred by the machine learning model from a set of the entity attributes. At least a portion of the entity attributes can include conditional entity attributes, which are a particular type of entity attribute that depends on the values of one or more of the other entity attributes. The computing system can present, via a graphical user interface (GUI), a visual representation of the inferred dynamic data structure. For example, the computing system can present the data sources to the tenant (e.g., an executive or administrator of the tenant) that owns the data in order for the tenant to query the data and/or perform other operations associated with the data.

In some embodiments, the computing system can track user interactions received through the GUI. The user interactions may be associated with the visual representation of the inferred dynamic data structure. The computing system can use the tracked interactions to dynamically adjust, using one or more other machine learning models, the inferred dynamic data structure. The computing system can then present, via the GUI, the dynamically adjusted inferred dynamic data structure.

A claimed solution rooted in computer technology overcomes problems specifically arising in the realm of computer technology. In various embodiments, a computing system (e.g., automated data classification system) is configured to obtain a data model associated with one or more tenants of a multi-tenant platform. The computing system can ingest data from one or more data sources. For example, the data can include tabular data (e.g., an Excel spreadsheet) having attributes (e.g., columns, rows). The computing system can generate a natural language summary of the underlying data (e.g., data in the columns and/or rows). For example, the computing system may use a generative artificial intelligence model (e.g., a large language model) to generate the natural language summary. The computing system can also generate another natural language summary of the data model. For example, the computing system may use the same or different generative artificial intelligence model to generate the natural language summary of the data model. The computing system can then compare the natural language summaries and determine which portions of the different natural language summaries match. Based on these matches, the computing system can automatically classify the data correctly without requiring a user to manually classify data, which can be inefficient and inaccurate. For example, the comparison of natural language summaries can allow the computing system to determine that one of the columns of data is for phone numbers, another column of the data is for addresses, and so forth.

In various embodiments, a computing system is configured to identify matching data records within a set of data records and merge the matching data records. Using the entity resolution request, the computing system can identify attributes in a data model. The computing system can then identify other attributes in the data model and/or other data models.

In various embodiments, a unique architecture enables efficient modeling of entities, relationships, and interactions that typically form the basis of a business. These models enable insights, scalability, and management not previously available in the prior art. It will be appreciated that with the information model discussed herein, there is no need to consider tables, foreign keys, or any of the low-level physicality of how the data is stored.

An information model may be utilized as a part of a multi-tenant platform. In a specific implementation, a configuration sits in a layer on top of the RELTIO™ platform and natively enjoys capabilities provided by the platform such as matching, merging, cleansing, standardization, workflow, and so on. Entities established in a tenant may be associated with custom and/or standard interactions of the platform. The ability to hold and link three kinds of data (i.e., entities, relationships, and interactions) in the platform and leverage the confluence of them in one place provides unlimited power to model and understanding to a business.

In various embodiments, the metadata configuration is based on an n-layer model. One example is a 3-layer model (e.g., which is the default arrangement). In some embodiments, each layer is represented by a JSON file (although it will be appreciated that many different file structures may be utilized such as BSON or YAML).

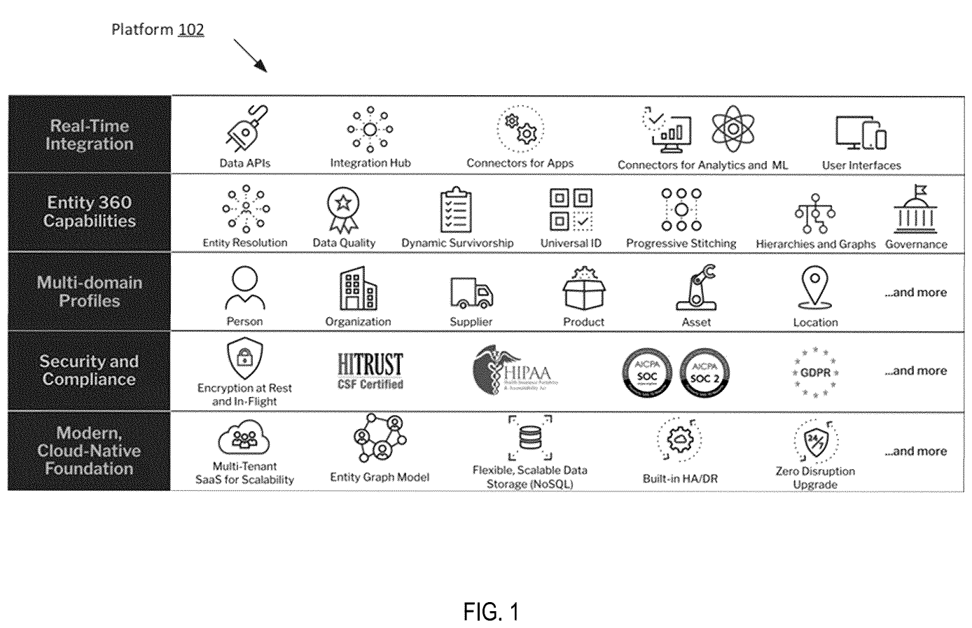

The information models may be utilized as a part of a connected, multi-tenant system. FIG. 1 depicts a platform 102. The platform 102 enables seamless scaling in many operational or analytical use case. The platform 102 may be the foundation of master data management (MDM). Various integration options, including a low-code/no-code solution, allow rapid deployment and time to value.

FIG. 1 is an example of functions of the platform 102 in some embodiments. The platform 102 may support best in class MDM capabilities, including identity resolution, data quality, dynamic survivorship for contextual profiles, universal ID across all your operational applications and hierarchies, knowledge graph to manage relationships, progressive stitching to create richer profiles, and governance capabilities. Further, the platform 102 may support high volume transactions, high volume API calls, sophisticated analytics, and back-end jobs for any workload in an auto-scaling cloud environment. As follows, the platform 102 may support high redundancy, fault tolerance, and availability with built-in NoSQL database, Elasticsearch, Spark, and other AWS and GCP services across multiple zones.

In various embodiments, the platform 102 is multi-domain and enables seamless integration of many types of data and from many sources to create master profiles of any data entity—person, organization, product, location. Users can create master profiles for consumers, B2B customers, products, assets, sites, and connect them to see the complete picture.

The platform 102 may enable API-first approach to data integration and orchestration. Users (e.g., tenants) can use APIs, and various application-specific connectors to ease integration. Additionally, in some embodiments, users can stream data to analytics or data science platforms for immediate insights.

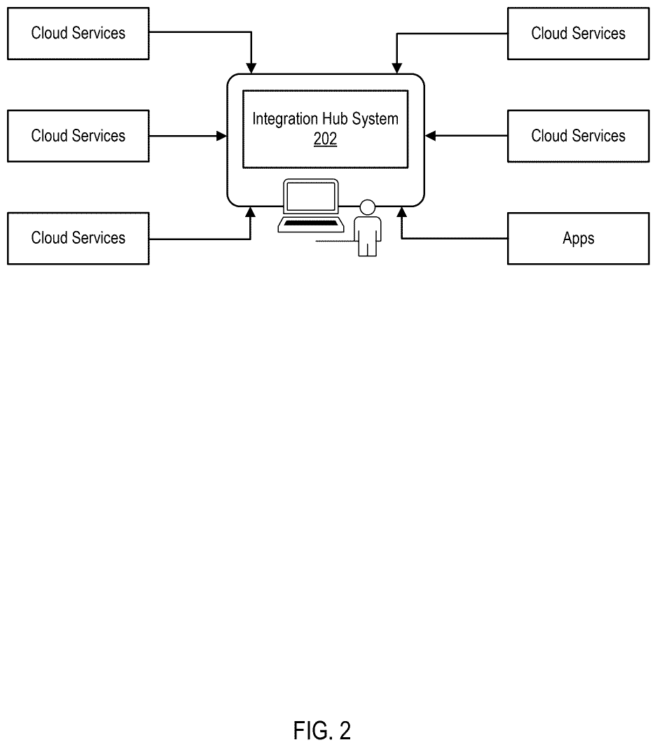

FIG. 2 depicts an environment for an integration hub system 202. The integration hub system 202 may connect various data sources and downstream consumers. In some embodiments, the integration hub system 202 comes with over 1,000 connectors to build data pipelines right. The integration hub system 202 may include an intuitive drag-and-drop graphical interface to create simple replication pipelines to complex data extraction and transformation tasks. With pre-built community recipes for common use cases, users can set up integration workflows in just a few clicks.

Along with the built-in data loader, event streaming capabilities, data APIs, and partner connectors, the integration hub system 202 enables rapid links to user systems using the platform 102. The integration hub system 202 may enable users to build automated workflows to get data to and from the platform 102 with any number of SaaS applications in just hours or days. Faster integration enables faster access to unified, trusted data to drive real-time business operations.

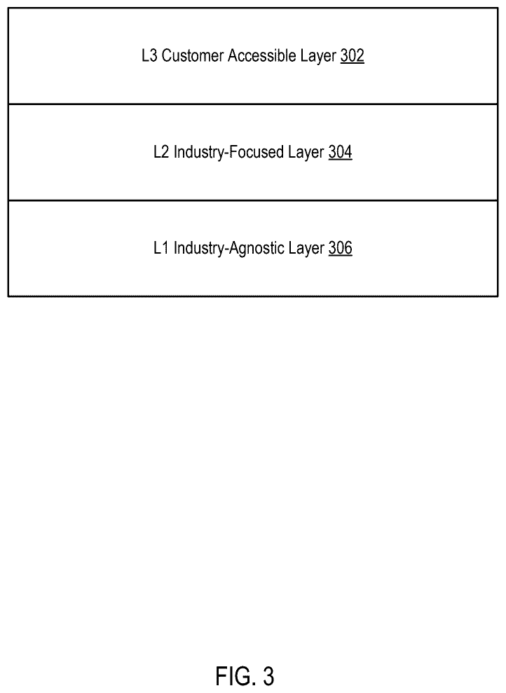

FIG. 3 depicts a three-layer model in some embodiments. Of the three layers, only layer 3 (e.g., the top layer of the n-layer model) 302, known as the “L3” is accessible by the customer. It is the layer that is a part of a tenant. The information associated with the L3 layer 302 may be retrieved from the tenant, edited. and applied back to the tenant using Configuration API.

The L3 302 layer typically inherits from the L2 layer 304 (an industry-focused layer) which in turn inherits from the L1 layer 306 (An industry-agnostic layer). Usually, the L3 layer 302 refers to an L2 304 container and inherits all data items (or “objects”) from the L2 304 container. However, it is not required that the L3 302 refer to the L2 304 container, it can standalone.

The L2 layer 304 may inherit the objects from the L1 layer. Whereas there is only a single L1 306 set of objects, the objects at the L2 layer 304 may be grouped into industry-specific containers. Like the L1 layer 306, the containers at the L2 layer 304 may be controlled by product management and may not be accessible by customers.

Life sciences is a good example of an L2 layer 304 container. The L2 layer 304 container 304 may inherit the Organization entity type (discussed further herein) from L1 layer 306 and extends it to the Health Care Organization (HCO) type needed in life sciences. As such, the HCO type enjoys all of the attribution and other properties of the Organization type, but defines additional attributes and properties needed by an HCO.

The L1 layer 306 may contain entities such as Party (an abstract type) and Location. In some embodiments, the L1 layer 306 contains a fundamental relationship type called HasAddress that links the Party type to the Location type. The L1 layer 306 also extends the Party type to Organization and Individual (both are non-abstract types).

There may be only one L1 layer 306, and its role is to define industry-agnostic objects that can be inherited and utilized by industry specific layers that sit at the L2 layer 304. This enables enhancement of the objects in the L1 layer 306, potentially affecting all customers. For example, if an additional attribute was added into the HasAddress relationship type, it typically would be available for immediate use by any customer of the platform.

Any object can be defined in any layer. It is the consolidated configuration resulting from the inheritance between the three layers that is commonly referred to as the tenant configuration or metadata configuration. In a specific implementation, metadata configuration consolidates simple, nested, and reference attributes from all the related layers. Values described in the higher layer overrides the values from the lower layers. The number of layers does not affect the inheritance.

In a specific implementation, metadata configuration consolidates simple, nested, and reference attributes from all the related layers. Values described in the higher layer overrides the values from the lower layers. The number of layers does not affect the inheritance.

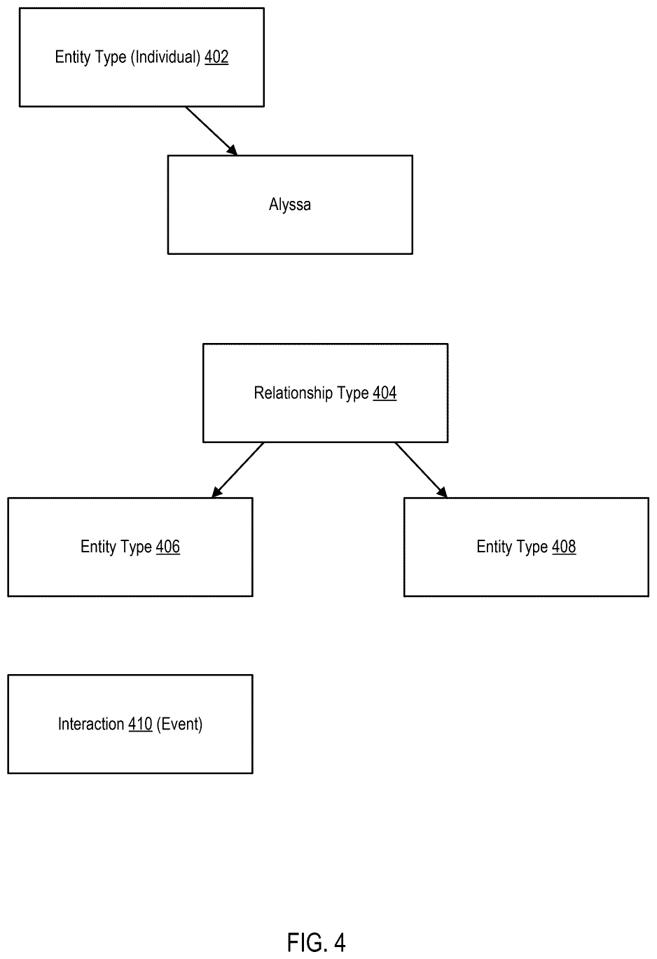

FIG. 4 is a box diagram of some examples of entity type, relationship type and event metadata. The platform 102 enables object types entities, relationships, and interactions. The entity type 402 may be a class of entity. For example, “Individual” is an entity type 402, and “Alyssa” represents a specific instance of that entity type. Other common examples of entity types include “Organization,” “Location,” and “Product.”

Often, entity types can materialize in single instances, such as the “Alyssa” example above. In another example, the L1 layer may define the abstract “Party” entity type with a small collection of attributes. The L1 layer may then be configured to define the “Individual” entity type and the “Organization” entity type, both of which inherit from “Party,” both of which are non-abstract and both of which add additional attributes specific to their type and business function. Continuing with the concept of inheritance, in the L2 Life Sciences container, the HCP entity may be defined (to represent physicians) which inherits from the “Individual” type but also defines a small collection of attributes unique to the HCP concept. Thus, there is an entity taxonomy “Party,” “Individual,” or “HCP,” and the resulting HCP entity type provides the developer and user with the aggregate attribution of “Party,” “Individual,” and “HCP.”

Once the entity types are defined, the user can link entities together in a data model by using the relationship type. Once the user defines entity types, they can be linked by defining relationships between them. For example, a user can post a relationship independently to link two entities together, or the client can mention a relationship in a JSON, which then posts the relationship and the two entities all at once.

A relationship type 404 describes the links or connections between two specific entities (e.g., entities 406 and 408). A relationship type 404 and the entities 406 and 408 described together form a graph. Some common relationship types are Organization to Organization, Subsidiary Of, Partner Of, Individual to Individual, Parent of/Child Of, Reports To, Individual to Organization/Organization to Individual, Affiliated With, Employee Of/Contractor Of.

Once the user defines entity types, they can be linked by defining relationships between them. For example, a user can post a relationship independently to link two entities together, or the client can mention a relationship in a JSON, which then posts the relationship and the two entities all at once.

The platform 102 may enable the user to define metadata properties and attributes for relationship types. The user can define up to any number metadata properties. The user can also define several attributes for a relationship type, such as name, description, direction (undirected, directed, bi-directional), start and end entities, and more. Attributes of one relationship type can inherit attributes from other relationship types.

Hierarchies may be defined through the definition of relationship subtypes. For example, if a user defines “Family” as a relationship type, the user can define “Parent” as a subtype. One hierarchy contains one or many relationship types; all the entities connected by these relationships form a hierarchy. Entity A>HasChild (Entity B)>HasChild (Entity C). Then A, B, and C form a hierarchy. In the same hierarchy, the user can add Subsidiary as a relationship and if Entity D is subsidiary of Entity C, then A, B, C, and D all become part of a single hierarchy.

Interactions 410 are lightweight objects that represent any kind of interaction or transaction. As a broad term, interaction 410 stands for an event that occurs at a particular moment such as a retail purchase or a measurement. It can also represent a fact in a period of time such as a sales figure for the month of June.

Interactions 410 may have multiple actors (entities), and can have varying record lengths, columns, and formats. The data model may be defined using attribute types. As a result, the user can build a logical data model rather than relying on physical tables and foreign keys; define entities, relationships, and interactions in granular detail; make detailed data available to content and interaction designers; provide business users with rich, yet streamlined, search and navigation experiences.

In various embodiments, four manifestations of the attribute type include Simple, Nested, Reference, and Analytic. The simple attribute type represents a single characteristic of an entity, relationship, or interaction. The nested, reference and analytic attribute types represent combinations or collections of simple sub-attribute types.

The nested attribute type is used to create collections of simple attributes. For example, a phone number is a nested attribute. The sub-attributes of a phone number typically include Number, Type, Area code, Extension. In the example of a phone number, the sub-attributes are only meaningful when held together as a collection. When posted as a nested attribute, the entire collection represents a single instance, or value, of the nested attribute. Posts of additional collections are also valid and serve to accumulate additional nested attributes within the entity, relationship or interaction data type.

The reference attribute type facilitates easy definition of relationships between entity types in a data model.

A user may utilize the reference attribute type when they need one entity to make use of the attributes of another entity without natively defining the attributes of both. For example, the L1 layer in the information model defines a relationship that links an Organization and an Individual using the affiliated with relationship type. The affiliated with relationship type defines the Organization entity type to be a reference attribute of the Individual entity type. This approach to data modeling enables easier navigation between entities and easier refined search.

Easier navigation between entities: In the example of the Organization and Individual entities that are related using the affiliated with relationship type, specifying an attribute of previous employer for the Individual entity type enables this attribute to be presented as a hyperlink on the individual's profile facet. From there, the user can navigate easily to the individual's previous employer.

Easily refined search: When attributes of a referenced entity and relationship type are available to be indexed as though they were native to the referencing entity, business users can more easily refine search queries. For example, in a search of a data set that contains 100 John Smith records, entering John Smith in the search box will return 100 John Smith records. Adding Acme to the search criteria will return only those records with John Smith that have a reference, and thus an attribute, that contains the word Acme.

The analytic attribute type is lightweight. In various embodiments, it is not managed in the same way that other attributes are managed when records come together during a merge operation. The analytic attribute type may be used to receive and hold values delivered by an analytics solution.

The user may utilize the analytic attribute type when they want to make a value from your analytics solution, such as Reltio Insights, available to a business user or to other applications using the Reltio Rest API. For example, if an analytics implementation calculates a customer's lifetime value and the user needs that value to be available to the user while they are looking at the customer's profile, the user may define an analytic attribute to hold this value and provide instructions to deliver the result of the calculation to this attribute.

In a specific implementation, the platform 102 assigns entity IDs (EIDs) to each item of data that enters the platform. As such, the platform can appropriately be characterized as including an EID assignment engine. Importantly, a lineage-persistent relational database management system (RDBMS) retains the EIDs for each piece of data, even if the data is merged and/or assigned a new EID. As such, the platform can appropriately be characterized as including a legacy EID retention engine, which has the task of ensuring when new EIDs are assigned, legacy EIDs are retained in a legacy EID datastore. The legacy EID retention engine can at least conceptually be divided into a legacy EID survivorship subengine responsible for retaining all EIDs that are not promoted to primary EID as legacy EIDs and a lineage EID promotion subengine responsible for promoting an EID of a first data item merged with a second data item to primary EID of the merged data item. An engine responsible for changing data items, including merging and unmerging (previously merged) data items can be characterized as a data item update engine. Cross-tenant durability also becomes possible when legacy EIDs are retained. In a specific implementation, a cross-tenant durable EID lineage-persistent RDBMS has an n-Layer architecture, such as a 3-Layer architecture.

Data may come from multiple sources. The process of receiving data items can be referred to as “onboarding” and, as such, the platform 102 can be characterized as including a new dataset onboarding engine. Each data source is registered and, in a specific implementation, all data that is ultimately loaded into a tenant will be associated with a data source. If no source is specified when creating a data item (or “object”), the source may have a default value. As such, the platform can be characterized as including an object registration engine that registers data items in association with their source.

A crosswalk can represent a data provider or a non-data provider. Data providers supply attribute values for an object and the attributes are associated with the crosswalk. Non-data providers are associated with an overall entity (or relationship); it may be used to link an L1 (or L2) object with an object in another system. Crosswalks do not necessarily just apply to the entity level; each supplied attribute can be associated with data provider crosswalks. Crosswalks are analogous to the Primary Key or Unique Identifier in the RDBMS industry.

The engines and datastores of the platform 102 can be connected using a computer-readable medium (CRM). A CRM is intended to represent a computer system or network of computer systems. A “computer system,” as used herein, may include or be implemented as a specific purpose computer system for carrying out the functionalities described in this paper. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

Memory of a computer system includes, by way of example but not limitation, random access memory (RAM), such as dynamic RAM (DRAM) and static RAM (SRAM). The memory can be local, remote, or distributed. Non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. During execution of software, some of this data is often written, by a direct memory access process, into memory by way of a bus coupled to non-volatile storage. Non-volatile storage can be local, remote, or distributed, but is optional because systems can be created with all applicable data available in memory.

Software in a computer system is typically stored in non-volatile storage. Indeed, for large programs, it may not even be possible to store the entire program in memory. For software to run, if necessary, it is moved to a computer-readable location appropriate for processing, and for illustrative purposes in this paper, that location is referred to as memory. Even when software is moved to memory for execution, a processor will typically make use of hardware registers to store values associated with the software, and a local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus of a computer system can couple a processor to an interface. Interfaces facilitate the coupling of devices and computer systems. Interfaces can be for input and/or output (I/O) devices, modems, or networks. I/O devices can include, by way of example but not limitation, a keyboard, a mouse or other pointing device, disk drives, printers, a scanner, and other I/O devices, including a display device. Display devices can include, by way of example but not limitation, a cathode ray tube (CRT), liquid crystal display (LCD), or some other applicable known or convenient display device. Modems can include, by way of example but not limitation, an analog modem, an IDSN modem, a cable modem, and other modems. Network interfaces can include, by way of example but not limitation, a token ring interface, a satellite transmission interface (e.g., “direct PC”), or other network interface for coupling a first computer system to a second computer system. An interface can be considered part of a device or computer system.

Computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine, or through multiple engines. As used in this paper, an engine includes at least two components: 1) a dedicated or shared processor or a portion thereof; 2) hardware, firmware, and/or software modules executed by the processor. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors, or a first engine and a second engine can share one or more processors with one another or other engines. Depending upon implementation-specific or other considerations, an engine can be centralized, or its functionality distributed. An engine can include hardware, firmware, or software embodied in a computer-readable medium for execution by the processor. The processor transforms data into new data using implemented data structures and methods, such as is described with reference to the figures in this paper.

The engines described in this paper, or the engines through which the systems and devices described in this paper can be implemented as cloud-based engines. As used in this paper, a cloud-based engine is an engine that can run applications and/or functionalities using a cloud-based computing system. All or portions of the applications and/or functionalities can be distributed across multiple computing devices and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations, while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud based datastore is a datastore that is compatible with cloud-based computing systems and engines.

Assuming a CRM includes a network, the network can be an applicable communications network, such as the Internet or an infrastructure network. The term “Internet” as used in this paper refers to a network of networks that use certain protocols, such as the TCP/IP protocol, and possibly other protocols, such as the hypertext transfer protocol (HTTP) for hypertext markup language (HTML) documents that make up the World Wide Web (“the web”). More generally, a network can include, for example, a wide area network (WAN), metropolitan area network (MAN), campus area network (CAN), or local area network (LAN), but the network could at least theoretically be of an applicable size or characterized in some other fashion (e.g., personal area network (PAN) or home area network (HAN), to name a couple of alternatives). Networks can include enterprise private networks and virtual private networks (collectively, private networks). As the name suggests, private networks are under the control of a single entity. Private networks can include a head office and optional regional offices (collectively, offices). Many offices enable remote users to connect to the private network offices via some other network, such as the Internet.

Matching is a powerful area of functionality and can be leveraged in various ways to support different needs. The classic scenario is that of matching and merging entities (Profiles). Within the architecture discussed herein, relationships that link entities can also and often do match and merge into a single relationship. This may occur automatically and is discussed herein.

Matching can be used on profiles within a tenant to deduplicate them. It can be used externally from the tenant on records in a file to identify records within that file that match to profiles within a tenant. Matching may also be used to match profiles stored within a Data Tenant to those within a tenant.

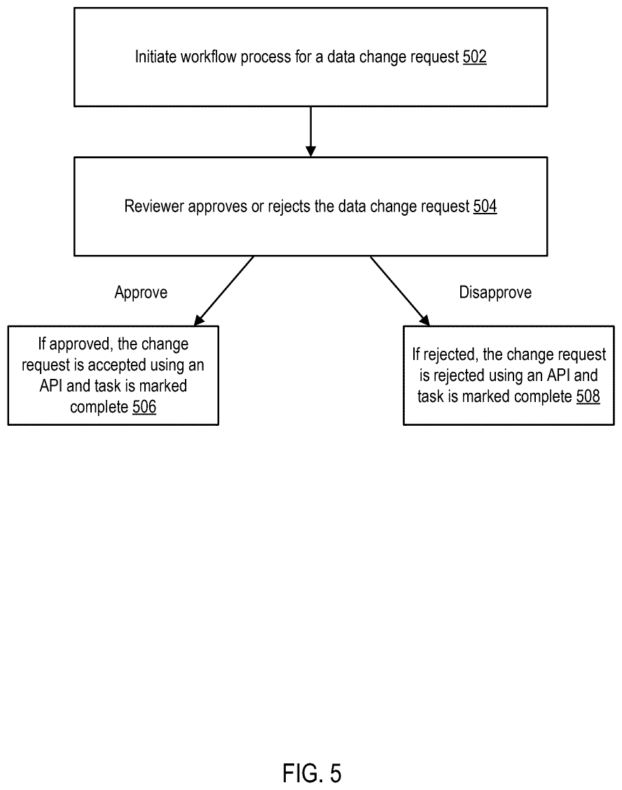

FIG. 5 depicts a flowchart of an example of a method of a dynamic matching facilitation. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

In some embodiments, a workflow is a series of sequential steps or tasks that are carried out based on user-defined rules or conditions to execute a business process. The Workflow may allow a user to manage complex business processes through a series of predetermined steps or tasks. The platform 102 may utilize the workflow to enable processes and tasks management, including the assignment and tracking of the tasks. A workflow process may support a creator, a create date, a due date, an assignee, steps, and comments. In various embodiments, workflow business processes are configurable. In some embodiments, the various actors and triggers in a workflow are Actors: The people and processes that participate in the workflow are the actors, e.g., Reviewer, Workflow Engine, Hub, and API; Reviewer: The user will be assigned with the role ROLE REVIEWER; Trigger: It is a scheduled process that scans activity logs to initiate a review workflow, e.g., from the UI, you can start a Data Change Request workflow to review the updates or the changes to the entities or the profiles data in your tenant. The workflow feature may allow a user to manage business processes through a series of predetermined steps or tasks which enables you to plan and coordinate user tasks, validations, reviews, and approvals for multiple records.

Data Change Request (DCR) is a collection of suggested data changes. Users who do not have rights to update objects, such as the customer sales representatives, can suggest changes. These suggested changes will be accumulated in Data Change Requests queued for review and approval by people with approval privileges, such as the data stewards. Examples of suggested data changes include adding a new attribute value, updating an attribute value, deleting an attribute value, and creating a new object along with referenced objects. Data Change Requests can be initiated using web browser-based user interface for Desktop or Mobile. An example of a step can be a user task assigned to users for Review and Approval of the data change request. In this example, a Workflow for a Data Change Request (DCR) includes the following sequence of steps in the flowchart of FIG. 5.

In module 502, on the profile page in Hub, users can initiate the DCR workflow process in the Suggesting mode.

In module 504, the Reviewer can Approve or Reject the DCR. In the Data Change Request Review pane of the UI, sub-attributes within the nested, reference, or complex attributes, and parent-nested attributes, have a label of the attribute value.

In module 506, if the Reviewer approves the DCR, the change request is accepted using the API and the task is marked complete.

In alternative module 508, if the Reviewer rejects the DCR, the change request is rejected using the API and the task is marked complete. In the Inbox, you have the option of partially rejecting changes from a DCR. In various embodiments, a reviewer may selectively reject attributes and approve a DCR partially.

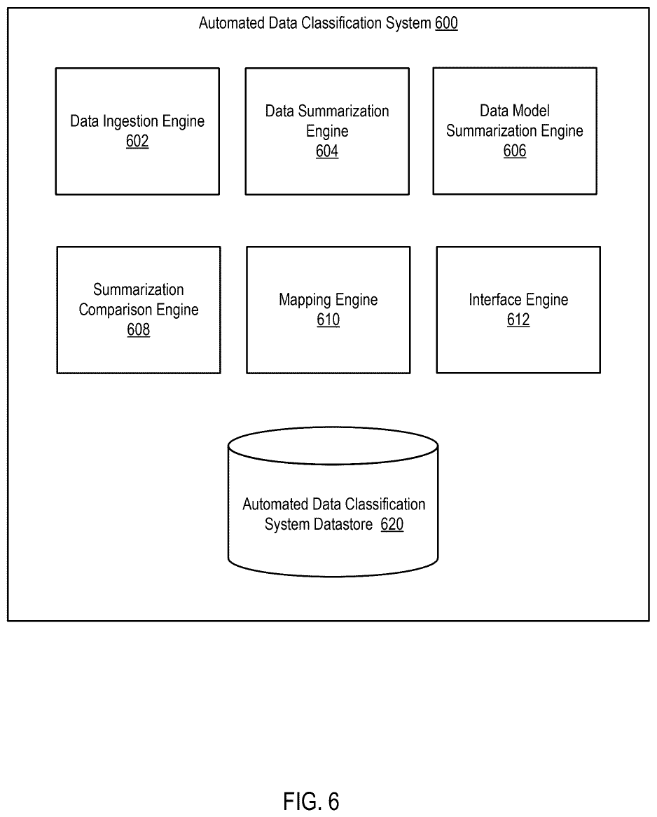

FIG. 6 depicts a diagram of an example automated data classification system 600. In the example of FIG. 6, the automated data classification system 600 includes a data ingestion engine 602, a data summarization engine 604, a data model summarization engine 606, a summarization comparison engine 608, a mapping engine 610, an interface engine 612, and an automated data classification system datastore 620. The machine learning vectorization system 600 may be a component of the platform 102 and/or cooperate with the platform 102.

The data ingestion engine 602 is intended to represent an engine that ingests data from a variety of different data sources having a variety of different data formats. The data ingestion engine 602 can ingest data across one or more communications networks (e.g., WAN, LAN, Internet, VPN, etc.). In some embodiments, the data ingestion engine 602 may normalize ingested data (e.g., using one or more normalization functions).

The data summarization engine 604 is intended to represent an engine that obtains one or more generative artificial intelligence models (e.g., large language models, omnimodal models) and generates a summary (e.g., natural language summary) of data (e.g., data ingested by the data ingestion engine 602). The data summarization engine 604 may generate a prompt automatically (e.g., without requiring user input) and/or based on an input (e.g., a user input), such as ““what column is what?” This can trigger the data summarization engine 604 to generate the natural language summary identifying (or, classifying) the different columns of the data. For example, the summary might indicate that one of the columns is names, another column is phone numbers, another column is addresses, and so forth. The data summarization engine 604 may also store context based on the input which can later be used by the summarization comparison engine 608. For example, the context may be the natural language summary (or portions thereof) and the prompt.

The data model summarization engine 606 is intended to represent an engine that obtains one or more generative artificial intelligence models (e.g., large language models, omnimodal models) and generates a summary (e.g., natural language summary) of one or more data models (e.g., a master data model, data model of one or more tenants of the platform 102). For example, the summary may indicate different attributes (e.g., fields, relationships, objects, etc.) of the data model. There could be hundred hundreds, thousands, or even more, attributes of the data model.

In some embodiments, the data model summarization engine 606 may generate a prompt automatically (e.g., without requiring user input) and/or based on an input (e.g., a user input), such as ““what attributes are in this data model?” This can trigger the data model summarization engine 606 to generate the natural language summary of the data model. The data summarization engine 604 may also store context which can later be used by the summarization comparison engine 608. For example, the context may be the natural language summary (or portions thereof) of the data model and the prompt.

The summarization comparison engine 608 is intended to represent an engine that can compare natural language summaries (e.g., of the data and the data model) and automatically classify, based on the comparison, portions of the data as corresponding to appropriate attributes of the data model. For example, the summarization comparison engine 608 can compare the natural language summaries to determine that one column of data is phone numbers, another column of data is addresses, another column of data is names, and the like. In some embodiments, the summarization comparison engine 608 includes one or more generative artificial intelligence models (e.g., large language models, omnimodal models).

The mapping engine 610 is intended to represent an engine that maps data to existing data structures of the platform 102 based on the comparison of the natural language summaries of the data and the data model. In a specific implementation, the mapping engine 610 maps a file in an MDM datastore. Advantageously, the automated data classification system 600 removes the need to perform explicit mapping for loading new data sources and reduces the time for onboarding new data sets. For example, if a file has a phone number, the MDM platform (e.g., automated data classification system 600) knows where to put it without being explicitly told to do so. Data can be automatically identified and mapped by the mapping engine 610 to existing data structures. In some embodiments, this automated mapping can be applied to data catalogs and even identification and automated ingestion of data based on data catalogs.

The interface engine 612 is intended to represent an engine that presents visual, audio, and/or haptic information. In some implementations, the interface engine 612 generates graphical user interface components (e.g., server-side graphical user interface components) that can be rendered as complete graphical user interfaces on various systems (e.g., client systems). The interface engine 612 can function to present an interactive graphical user interface for display and receiving information.

In some embodiments, the interface engine 612 may facilitate cooperation between systems. For example, the interface engine 612 may facilitate cooperation between the automated data classification system 600 and the conditional attribute system 1400.

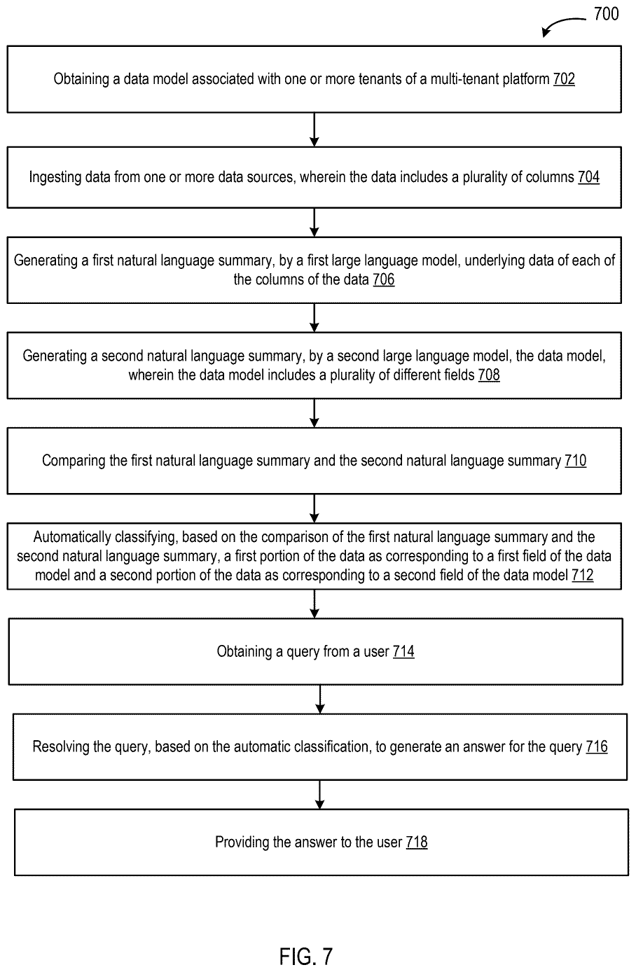

FIG. 7 depicts a flowchart 700 of an example method of automated data classification. In this and other flowcharts, flow diagrams, and/or sequence diagrams, the flowchart illustrates by way of example a sequence of modules (or, steps). It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

In module 702, a computing system (e.g., automated data classification system 600) obtains a data model associated with one or more tenants of a multi-tenant platform. In some embodiments, a data model summarization engine (e.g., data model summarization engine 606) obtains the data model.

In module 704, the computing system ingests data from one or more data sources, wherein the data includes a plurality of columns. In some embodiments, a data ingestion engine (e.g., data ingestion engine 602) ingests the data.

In module 706, the computing system generates generating a first natural language summary, by a first large language model, underlying data of each of the columns of the data. In some embodiments, a data summarization engine (e.g., data summarization engine 604) generates the first large language model. For example, a first large language model of the data summarization engine may generate the summary.

In module 708, the computing system generates generating a second natural language summary, by a second large language model, the data model, wherein the data model includes a plurality of different fields. The second large language model may be same or different from the first large language model. In some embodiments, the data model summarization engine 606 generates the second natural language summary. For example, a large language model of the data model summarization engine may generate the second natural language summary.

In module 710, the computing system compares the first natural language summary and the second natural language summary. In some embodiments, a summarization comparison engine (e.g., summarization comparison engine 608) performs the comparison.

In module 712, the computing system automatically classifies, based on the comparison of the first natural language summary and the second natural language summary, a first portion of the data as corresponding to a first field of the data model and a second portion of the data as corresponding to a second field of the data model. In some embodiments, a mapping engine (e.g., mapping engine 610) performs the automatic classification.

In module 714, a platform (e.g., platform 102) obtains a query from a user. In module 716, the platform resolves the query, based on the automatic classification, to generate an answer for the query. In module 718, the platform provides the answer to the user.

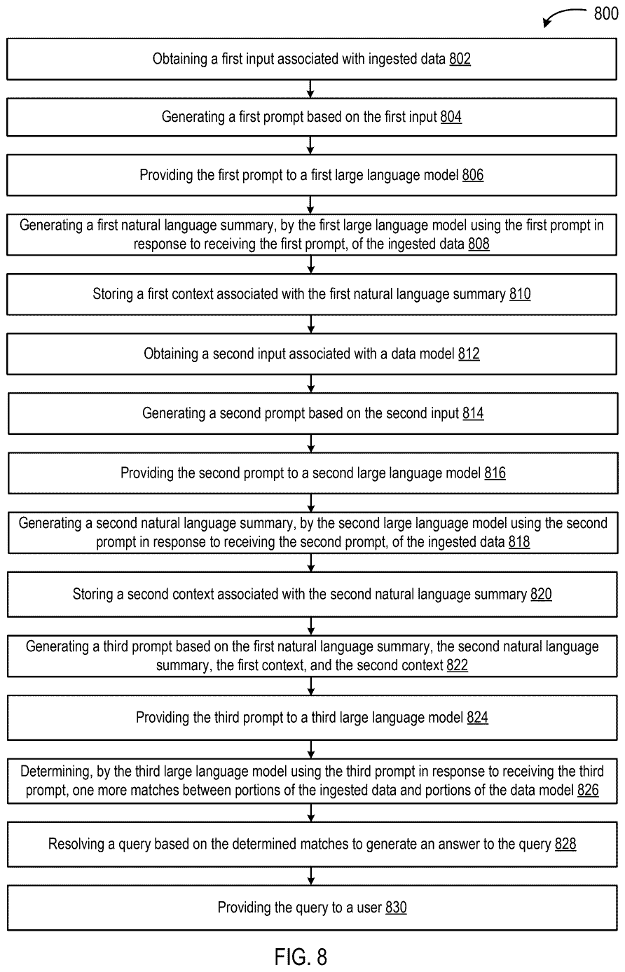

FIG. 8 depicts a flowchart 800 of an example method of automated data classification. In this and other flowcharts, flow diagrams, and/or sequence diagrams, the flowchart illustrates by way of example a sequence of modules (or, steps). It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

In module 802, a computing system (e.g., automated data classification system 600) obtains a first input associated with ingested data. For example, the first input may be “what column is what?” In some embodiments, a data summarization engine (e.g., data summarization engine 604) obtains the first input.

In module 804, the computing system generates a first prompt based on the first input. In some embodiments, the data summarization engine generates first prompt. The first prompt may be a generative artificial intelligence prompt (e.g., a large language model prompt).

In module 806, the computing system provides the first prompt to a first large language model. In some embodiments, the data summarization engine provides the first prompt to the first large language model. For example, the data summarization engine may include the first large language model.

In module 808, the computing system generates a first natural language summary, by the first large language model using the first prompt in response to receiving the first prompt, of the ingested data. In some embodiments, the data summarization engine generates the first natural language summary.

In module 810, the computing system stores a first context associated with the first natural language summary. In some embodiments, the data summarization engine stores the first context.

In module 812, the computing system obtains a second input associated with a data model. In some embodiments, a data model summarization engine (e.g., data model summarization engine 606) obtains the second input. For example, the second input may be a manually generated and/or automatically generated input for generating a summary of a data model.

In module 814, the computing system generates a second prompt based on the second input. In some embodiments, the data model summarization engine generates the second prompt.

In module 816, the computing system provides the second prompt to a second large language model. In some embodiments, the data model summarization engine provides the second prompt to the second large language model (e.g., of the data model summarization engine). The second large language model may be the same or different from the first large language model.

In module 818, the computing system generates a second natural language summary, by the second large language model using the second prompt in response to receiving the second prompt, of the ingested data. In some embodiments, the data model summarization engine generates the second natural language summary.

In module 820, the computing system stores a second context associated with the second natural language summary. In some embodiments, the data model summarization engine stores the second context.

In module 822, the computing system generates a third prompt based on the first natural language summary, the second natural language summary, the first context, and the second context. In some embodiments, a summarization comparison engine (e.g., summarization comparison engine 608) generates the third prompt.

In module 824, the computing system provides the third prompt to a third large language model. In some embodiments, the summarization comparison engine provide the third prompt to the third large language model. The third large language model may be the same or different as the first large language model and/or second large language model.

In module 826, the computing system determines, by the third large language model using the third prompt in response to receiving the third prompt, one more matches between portions of the ingested data and portions of the data model. In some embodiments, the summarization comparison engine determines the one or more matches.

In module 828, a platform (e.g., platform 102) resolves a query based on the determined matches to generate an answer to the query. In module 830, the platform provides the query answer to a user.

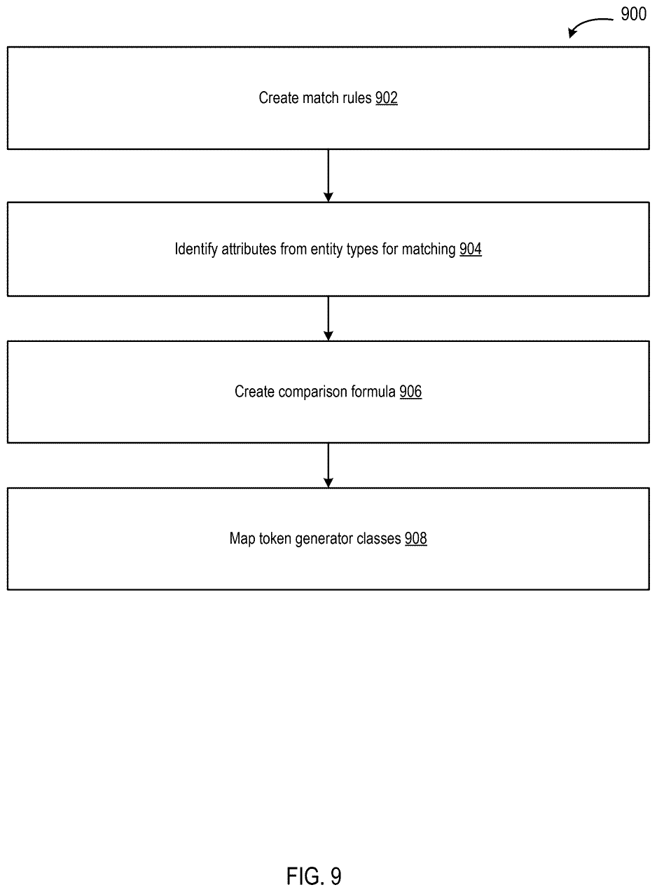

FIG. 9 depicts a dynamic matching facilitation flowchart. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

The match architecture is responsible for identifying profiles within the tenant that are considered to be semantically the same or similar. A user may establish a match scheme using the match configuration framework. In some embodiments, the user may utilize machine learning techniques to match profiles. In step 902, the user may create match rules. In step 904, the user may identify the attributes from entity types they wish to use for matching. In step 906, the user may write a comparison formula within each match rule which is responsible for doing the actual work of comparing one profile to another. In step 908, the user may map token generator classes that will be responsible for creating match candidates.

Unlike other systems, in various embodiments, the architecture is designed to operate in real-time. Prior to the match process and merge processes occurring, every profile created or updated is may be cleansed on-the-fly by the profile-level cleansers. Thus the 3-step sequence of cleanse, match, merge may be designed to all occur in real-time anytime a profile is created or updated. This behavior makes the platform 102 ideal for real-time operational use within a customer's ecosystem.

Lastly, the survivorship architecture is responsible for creating the classic “golden record”, but in a specific implementation, it is a view, materialized on-the-fly. It is returned to any API call fetching the profile and contains a set of “Operational Values” from the profile, which are selected in real-time based on survivorship rules defined for the entity type.

In various embodiments, matching may operate continuously and in real-time. For example, when a user creates or updates a record in the tenant, the platform cleanses and processes the record to find matches within the existing set of records.

Each entity type (e.g., contact, organization, product) may have its own set of match groups. In some embodiments, each match group holds a single rule along with other properties that dictate the behavior of the rule within that group. Comparison Operators (e.g., Exact, ExactOrNull, and Fuzzy) and attributes may comprise a single rule.

Match tokens may be utilized to help the match engine quickly find candidate match values. A comparison formula within a match rule may be used to adjudicate a candidate match pair and will evaluate to true or false (or a score if matching is based on relevance).

In some embodiments, the matching function may do one of three things with a pair of records: Nothing (if the comparison formula determines that there is no match); Issue a directive to merge the pair; Issue a directive to queue the pair for review by a data steward. In some embodiments, the architecture may include the following:

1) Entities and relationships each have configurable attribution capability.

2) Values found in an attribute are associated with a crosswalk held within an entity or relationship object. Each profile can have multiple crosswalks, each contributing one or more values. Data may come from multiple sources. Each source may be registered, and all data loaded into a tenant will be associated with a data source. Each supplied attribute may be associated with data provider crosswalks. Crosswalks are analogous to the Primary Key or Unique Identifier in relational database management system (RDBMS). A crosswalk can represent a data provider or a non-data provider.

3) Data providers supply attribute values for an object and the attributes are associated with the crosswalk.

4) Non-data providers are associated with an overall entity (or relationship). In this case it is simply used to link a Reltio object with an object in another system. Supplied attributes may NOT be associated with this crosswalk.

5) Profiles can be matched and merged, but relationships are also matched and merged. While the user may develop match rules to govern the matching and merging of profiles, merging of relationships is automatic and intrinsic to the platform. Any two relationships of the same type, that each have entity A at one endpoint and entity B at their other endpoint, will merge automatically.

6) An attribute is intrinsically multi-valued, meaning it can hold multiple values. This means any attribute can collect and store multiple values from contributing sources or through merging of additional crosswalks. Thus, if a match rule utilizes the first name attribute, then the match engine will by default, compare all values held within the first name attribute of record A to all values held within the first name attribute of record B, looking for matches among the values. The user may elect to only match on operational values if desired.

7) When two profiles merge, the resulting profile contains the aggregate of all the crosswalks of the two contributing profiles and thus the associated attributes and values from those crosswalks. The arrays behind the attributes naturally merge as well, producing for each attribute an array that holds the aggregation of all the values from the contributing attributes. Relationships benefit from the same architecture and behave in the same manner as described for merged entities. The surviving entity ID (or relationship ID) for the merged profile (or relationship) is that of the oldest of the two contributors. Other than that, there really isn't a concept of a winner object and a loser object.

8) When two profiles merge the resulting profile contains references to all the interactions that were previously associated with the contributing profiles. (Note that Interactions do not reference relationships.)

9) If profile B is unmerged from the previous merge of A and B, then B will be reinstated with its original entity ID. All of the attributes (and associated values), relationships, and interactions profile B brought into the merged profile will be removed from the merged profile and returned to profile B.

The matchGroups construct is a collection of match groups with rules and operators that are needed for proper matching. If the user needs to enable matching for a specific entity type in a tenant, then the user may include the matchGroups section within the definition of the entity type in the metadata configuration of the tenant. The matchGroups section will contain one or more match groups, each containing a single rule and other elements that support the rule.

Looking at a match group in a JSON editor, the user can easily see the high-level, classic elements within it. The rule may define a Boolean formula (see the and operator that anchors the Boolean formula in this example) for evaluating the similarity of a pair of profiles given to the match group for evaluation. It is also within the rule element that four other very common elements may be held: ignoreInToken (optional), Cleanse (optional), matchTokenClasses (required), and comparatorClasses (required). The remaining elements that are visible (URI, label, and so on), and some not shown in the snapshot, surround the rule and provide additional declarations that affect the behavior of the group and in essence, the rule.

Each match group may be designated to be one of four types: automatic, suspect, <custom>, and relevance_based described below. The type the user selects may govern whether the user develops a Boolean expression for the comparison rule or an arithmetic expression. The types are described below.

Behavior of the automatic type: With this setting for type, the comparison formula is purely Boolean and if it evaluates to TRUE, the match group will issue a directive of merge which, unless overridden through precedence, will cause the candidate pair to merge.

Behavior of the suspect type: With this setting for type, the comparison formula is purely Boolean and if it evaluates to TRUE, the match group will issue a directive of queue for review which, unless overridden through precedence, will cause the candidate pair to appear in the “Potential Matches View” of the MDM UI.

Behavior of the relevance_based type: Unlike the preceding rules, all of which are based on a Boolean construction of the rule formula, the relevance-based type expects the user to define an arithmetic scoring algorithm. The range of the match score determines whether to merge records automatically or create potential matches.

If a negativeRule exists in the matchGroups and it evaluates to true, any merge directives from the other rules are demoted to queue for review. Thus, in that circumstance, no automatic merges will occur. The Scope parameter of a match group defines whether the rule should be used for Internal Matching or External Matching or both. External matching occurs in a non-invasive manner and the results of the match job are written to an output file for the user to review. Values for Scope are: ALL—Match group is enabled for internal and external matching (Default setting). NONE—Matching is disabled for the match group. INTERNAL-Match group is enabled for matching records within the tenant only. EXTERNAL-Match group is enabled only for matching of records from an external file to records within the tenant; in a specific implementation, external matching is supported programmatically via an External Match API and available through an External Match Application found within a console, such as a RELTIO™ Console.

If set to true, then only the OV of each attribute will be used for tokenization and for comparisons. For example, if the First Name attribute contains “Bill”, “William”, “Billy”, but “William” is the OV, then only “William” will be considered by the cleanse, token, and comparator classes.

The rule is the primary component within the match group. It contains the following key elements each described in detail: IgnoreInToken, Cleanse, matchTokenClasses, comparatorClasses, Comparison formula.

A negative rule allows a user to prevent any other rule from merging records. A match group can have a rule or a negative rule. The negative rule has the same architecture as a rule but has the special behavior that if it evaluates to true, it will demote any directive of merge coming from another match group to queue for review. To be sure, most match groups across most customers' configurations use a rule for most matching goals. But in some situations, it can be advantageous to additionally dedicate one or more match groups to supporting a negative rule for the purpose of stopping a merge based on usually a single condition. And when the condition is met, the negative rule prevents any other rule from merging the records. So in practice, the user might have seven match groups each of which use a rule, while the eighth group uses a negative rule.

The platform 102 may include a mechanism to proactively monitor match rules in tenants across all environments. In some embodiments, after data is loaded into the tenant, the proactive monitoring system inspects every rule in the tenant over a period of time and the findings are recorded. Based on the percentage of entities failing the inspections, the proactive monitoring system detects and bypasses match rules that might cause performance issues and the client may be will be notified. The bypassed match rules will not participate in the matching process.

In various embodiments, the user receives a notification when the proactive monitoring system detects a match rule that needs review. ScoreStandalone and scoreIncremental elements may be used to calculate a Match Score for a profile that is designated as a potential match and can assist a data steward when reviewing potential matches.

Relevance-based matching is designed primarily as a replacement of the strategy that uses automatic and suspect rule types. With Relevance-based matching, the client may create a scoring algorithm of the user's own design. The advantage is that in most cases, a strategy based on Relevance-based matching can reduce the complexity and overall number of rules. The reason for this is that the two directives of merge and queue for review which normally require separate rules (automatic and suspect respectively) can often be represented by a single Relevance-Based rule.

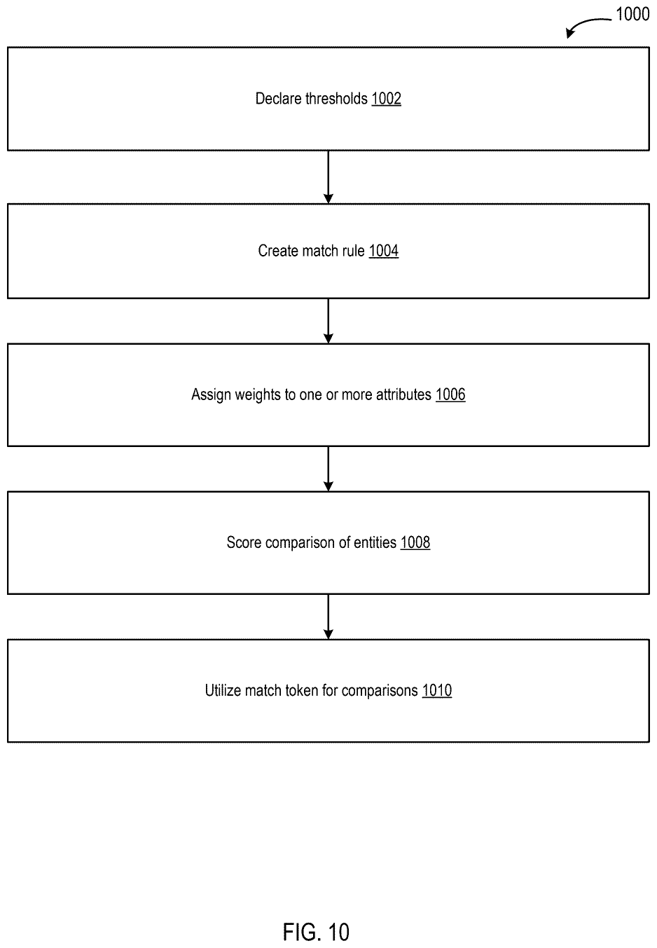

FIG. 10 depicts a dynamic matching flowchart. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

In step 1002, thresholds may be defined. For example, when declaring the ranges for queue_for_review and auto_merge, the combination should span the entire available range of 0.0 to 1.0 with no gap and no overlap except that the upper endpoint for queue_for_review should equal the lower endpoint for auto_merge thus have a common touchpoint between them (for example, 0.0 to 0.6 for queue_for_review, and 0.6 to 1.0 for auto_merge). If the actionThresholds leave a gap, then any score falling within the gap will produce no action. Conversely, if the action Thresholds overlap (for example, 0.4 to 0.6 for queue_for_review, and 0.5 to 0.7 for auto_merge) and a score lands within the intersection (0.55 in our example) or on the touchpoint, the directive of queue_for_review takes precedence.

In step 1004, match rules are created. Using Relevance-based matching, the client could create a match rule that contains a collection of attributes to test as a group.

In step 1006, weights may be assigned to attributes to govern their relative importance in the rule. Weights can be set from 0.0 to 1.0. If the client does not explicitly set a weight for an attribute, it may receive a default weight of 1.0 during execution of the rule. For example, starting with all weights equal to 1.0 and perhaps start with actionThresholds of 0.0-0.5 for queue_for_review and 0.5-1.0 for auto_merge. Do some trial runs and examine the results. If too many obvious matches are being set to queue_for_review, then weights may be adjusted and the action Thresholds modified (e.g., to perhaps 0.0-0.7, and 0.7-1.0). The user may iterate and experiment until able to get optimized results with the data set.

In step 1008, score comparison of entities is performed. In step 1010, the relevance_based match rules use the match token classes in the same way as they are used in suspect and automatic match rules. However, the comparison of the two entities works differently. Every comparator class provides relevance value while comparing values. The relevance is in the range of 0 to 1. For example, BasicStringComparator returns 0 if two values are different. It returns 1 if two values are the identical. Fractional values can be a result of DistinctWordsComparator or other comparators. Every attribute has assigned weights according to the importance of the attribute. If the weight is not assigned explicitly then it is equal to 1 for the simple attributes or Maximum of the weights of sub-nested attributes for nested or reference attributes. If an attribute has multiple values, then the maximum value of relevance is selected.

In various embodiments, the following information describes participants of the formulae: RelevanceScoreAND—the relevance score of AND operand, the relevance score of the match rule; Nsimple—number of simple attributes (e.g., FirstName, LastName) participating in the AND operator directly; weighti—configured weight of i-th simple attribute; relevancei—calculated relevance of i-th simple attribute; Nnest—number of nested and reference attributes (e.g., Phone-no, Email-ID, Address) participating in the AND operator directly; weightj—configured weight of j-th nested or reference attribute; relevancej—calculated relevance of j-th nested/reference attribute; Nlogical—number of logical operands (For example, AND or OR) participating in the AND operator directly; relevancek—calculated relevance of k-th logical operand (the weight of a logical operand is fixed to 1; RelevanceScoreOR=max (relevance1, . . . , relevancei, . . . , relevanceN) relevancei-relevance of simple attribute, nested attribute, logical operand participating in the OR operand directly; RelevanceScoreNOT=1-RelevanceScoreAND, OR, exact, . . . (The relevance score of the NOT operand is equal to 1 minus the relevance score of the operand having this negation.)

In various embodiments, the following information describes participants of the formulae:

$${RelevanceScore}_{AND} = \frac{{\sum }_{i = 1}^{{N}_{simple}} {weight}_{i} \cdot {relevance}_{i} + {\sum }_{j = 1}^{{N}_{next}} {weight}_{j} \cdot {relevance}_{j} + {\sum }_{i = 1}^{{N}_{logical}} {relevance}_{k}}{{\sum }_{i = 1}^{{N}_{simple}} {weight}_{i} + {\sum }_{j = 1}^{{N}_{next}} {weight}_{1} + {N}_{logical}}$$

BasicStringComparator provides the relevance values and the score is calculated as follows: true for First Name; true for LastName; false for Suffix. The score is calculated as (1*1+1*1+0*1)/(1+1+1)=?=0.66. With a score of 0.66 the directive for this pair will be set to queue_for_review.

The example below shows the use of the verifyMatches API when using Relevance-based matching. Noteworthy items are relevance values appear for every attribute comparison and relevance for the entire rule; Match action name is shown if the relevance is within the corresponding threshold range, and null if it is not within any action Threshold range; Matched field will be true if the relevance is within any actionThreshold range.

In the match group configuration, the user may define Weights and actionThresholds. The weight property allows the client to assign a relative weight (strength) for each attribute. For example, the user may decide that Middle Name is less reliable and thus less important than First Name.

The action Threshold allows the client to define a range of scores to drive a directive. For example, the user might decide that the match group should merge the profile pair if the score is between 0.9 to 1.0, but should queue the pair for review if the score falls into a lower range of 0.6 to 0.9.

The user can configure a relevance-based match rule with multiple action thresholds having the same action type but with a different relevance score range.

In the above example, the type is potential_match for two different action thresholds. The user can differentiate such thresholds by assigning appropriate labels. The user can generate potential matches with different labels based on the range of the relevance score that allows the user to differentiate between higher and lower relevance score matches. The user can resolve matches quickly based on the label. In the example above, based on the relevance score, some potential matches can be considered for merging directly while others must be reviewed before any action is taken. The results of the API to get potential matches and the external match API will contain a relevance value and a matchActionLabel corresponding to each of the action type configured under the action Threshold parameter. For more information, see Potential Matches API and External Match API.

Using operators like equals and notEquals prevents tokenization from generating tokens. These operators should not have an impact on tokenization, if we want to compare and conclude that even though address and/or email and/or phone are different, the remaining attributes match enough to take the score above the threshold.

In some embodiments, the following options equal, notEquals and in constraints: 1) strict (Boolean value with default=true): Allows the constraint to be skipped before the match tokens and relevance score are computed; 2) weight (decimal with default=0.0): Allows the constraint to participate in the relevance score calculation. (The two options and their default values ensure backward compatibility.)

An example of a formula to calculate relevance score is:

$$R = \frac{{\sum }_{i}^{N} {{R}^{operand}}_{i} \cdot {{w}^{operand}}_{i} + {\sum }_{i}^{N} {{R}^{constraint}}_{i} \cdot {{w}^{constraint}}_{i}}{{\sum }_{i}^{N} {{w}^{operand}}_{i} + {\sum }_{i}^{N} {{w}^{constraint}}_{i}}$$

The formulae have the following variables: Roperand—the relevance score of an operand (for example: exact, exactOrNull, exactOrAllNull, fuzzy, etc.); Rconstraint—the relevance score calculated for a constraint (for example: equals, notEquals, in); Woperand—configured weight for an operand; Wconstraint—configured weight for a constraint.

In at least some organizations, profiles are maintained across systems and there are instances where multiple records of the same profile exist. There may be inconsistencies in each record. In such cases, it would be beneficial to merge these records and maintain one record with the complete information. There are also instances where two profiles are related to each other.

There are certain match pairs that the user can configure such that the system can automatically take action on those. Other match pairs that require manual review are resolved using the Potential Match screen. Match rules and Match IQ (discussed herein) may be utilized to determine if two records are a match, not a match, or a potential match.

Match rules and Match IQ may be used to determine if two records are a match, not a match, or a potential match. The user can also use the Match Score to decide if a profile is a potential match. Based on predefined match rules, each potential match is given a Match Score and the higher the score, higher is the probability of it to be a potential match for the profile. In some embodiments, the Match Score of a potential match will have a value of more than 0 only if the standalone and incremental scores are configured for the match rules.

There may be instances when certain profiles, in spite of being a potential match, are excluded from the profile view due to these match rules. In such cases, the user can manually search by entering the search criteria in the “Search” field and include these profiles as potential matches.

The user may have the option of viewing the Potential Matches perspective in the classic mode or the new mode.

In various embodiments, Match IQ uses machine learning (ML) to simplify and accelerate the data matching process. With Match IQ, business users can easily create a model for matching the records, by simply selecting the entity type and related attributes, without or minimum IT help. They can then train the ML model with the active learning process by reviewing pairs of records and indicating which are a match and which are not. As users confirm the matches, machine learning adjusts the matching model and presents additional record pairs to further refine the model.

After a sufficient number of representative record pairs have been matched or not matched, the user can download and review the match results. A downloaded file may show a sample set of match results and a relevance score for each record pair. The higher the relevance score, the more likely the records match. If needed, the user can retrain the model by answering more questions or even creating an alternate model to compare the matching results.

After the results are satisfactory, the data steward or other user with approval authority can review, approve and publish the model to use with internal and/or external data. The user also provides publishing settings based upon the relevance score range—for example, to define that match pairs with a relevance score of 8 to 1 should be matched and merged.

The end-to-end process, driven and performed by business users, typically takes only a day or two to complete and produces the quality matches customers require. In some embodiments, Match IQ uses machine learning technology to help ensure unified and reliable data across virtually unlimited data sources. The ML matching model, created with active learning using resolutions of suspected matched pairs, can be effectively applied to future match pairs. This provides a consistent way for business users and data stewards to match and merge data for increased quality, reliability, and business value.

Once a matching model is trained, no user interaction is required but the model can be retrained if needed. Because match and merge operations are performed using these models and calculated relevance scores, the process is rapid, consistent, and reliable. As the business grows or changes, the models can easily be adjusted to accommodate additional data sources. This enables matching and merging at the scale and speed of business.

The streamlined matching process, which does not require IT specialists or coding, enables customers to get up and running faster and with less effort. Typically, they can progress from initial subscription to completing their match-and-merge operations in a matter of days. Compare this to the weeks or months required by more traditional approaches. This same process is used to perform matching for new data sources as they are added, providing additional time savings and increased productivity.

No definition of matching requirements is needed; instead, users select matched pairs and machine learning creates the models. This greatly reduces the possibility of matching requirements not being correctly identified that might generate incorrect matches or miss valid matches. In addition, because machine learning creates and adjusts the matching model without configuration by IT specialists, coding errors are a thing of the past. This not only reduces errors in the match-and-merge process, but it also saves significant time as it creates a repeatable process. Customers have an option to use both Match IQ and traditional rule-based matching together if needed.

With all the time saved by using Match IQ, those involved-data owners, data stewards, IT and other business users-will find they have more time available for work that adds value to the business. They can use their time to focus on creating better user experiences, data improvement initiatives or streamlining other processes.

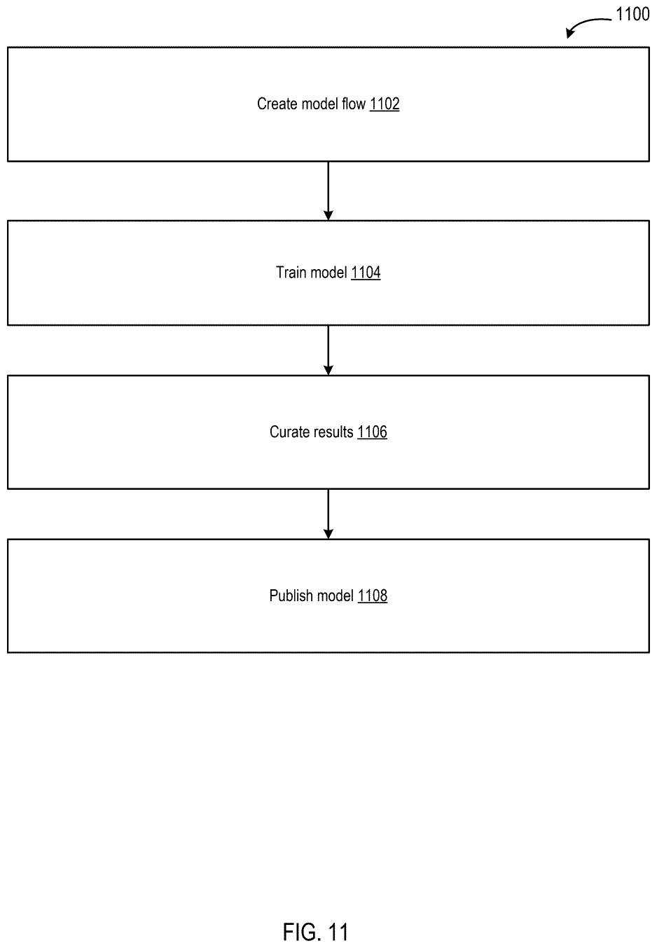

FIG. 11 depicts a high level flowchart for MatchIQ in some embodiments. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

In step 1102, the first step is to create a model flow by selecting entity types and attributes. In various embodiments, a graphical user interface may enable a user to select attributes to train the model (e.g., with a check system).

In step 1104, the model is trained. When the user trains a model, the user identifies records as matches or non-matches (e.g., by answering a series of questions). After the completion of the Preparing Data stage, the model moves under the Training lane. At this stage, the model is ready for training. There can be variations where records are neither close to matches nor non-matches. Such records then become the input to the training process where the user may be prompted with questions seeking confirmation on whether a particular pair is a match or not.

A machine learning methodology may be utilized. For example, a neural network may be utilized for training. Alternately, as other examples, gradient boosted decision trees or random forests may be utilized.

In step 1106, results are curated. In various embodiments, the graphical user interface may display details related to the model and results may be displayed (e.g., downloaded). Matches may be run and reviewed by the user to curate the results for further training and model improvement.

In step 1108, the user may publish the model. The user may choose to publish the model for internal and external matching. In some embodiments, the user may select external or internal.

For example, if the user selects external, the model may be used to match data from an external file with the data in the tenant. If the user selects internal, the model may be used to match the data within your tenant along with the match rules configured for the tenant.

In various embodiments, the user may define a custom action and a corresponding relevance score range. This allows the user to execute custom actions for relevance scores that are received for relevance-based rules. If a match pair falls within the defined range, then the custom action is executed. In a specific implementation, the relevance score range the user specifies for one action cannot overlap with the relevance score of another custom action.

In various embodiments, survivorship and merging are separate concepts and processes. Again, think of an entity as a container of crosswalks and their associated attributes and values. A merged entity may be an aggregation of crosswalks from two or more entities. The additional crosswalks continue to bring their own attributes and values with them. If the acquiring (winning) entity already has the same attribute URI that the incoming entity is bringing, then the values from the attributes will accumulate within the attribute, yet the integrity of which crosswalk each value within the attribute came from is maintained for several purposes including the need to return the attribute and its values to the original entity it came from if an unmerge is requested. If the acquiring entity does not already have the same attribute URI that the incoming entity is bringing, then the new attribute URI becomes established within the entity.

In some embodiments, unlike other MDM systems, survivorship is a separate process that doesn't occur during the merge. It is a process that executes in real-time when the entity is being retrieved during an API call. Survivorship may not depend on how the crosswalks and attributes came into the consolidated profile nor the order that they arrived. Survivorship processes each attribute according to the attribute's defined survivorship rule, and produces an Operational Value (OV) for the attribute on the fly. Depending on the type of survivorship rule selected, there could be one or more OVs for an attribute. For example, the user might choose the aggregation rule for the address attribute for the purpose of returning all addresses a person is related to. Conversely the user might choose the frequency rule for “first name” to return the one name that occurs most frequently in the “first name” attribute. Note also that the role of the username making the API call also factors into the survivorship rule used. This feature allows one survivorship rule for an attribute to be stored with one username role, while another survivorship rule for the same attribute is stored with another username role. A fetch of the entity by each username role might return different OVs.

When configuring the survivorship rules for the attributes of an entity type, the user can do this largely from the UI, but there are some advanced survivorship strategies that may be defined through metadata configuration.

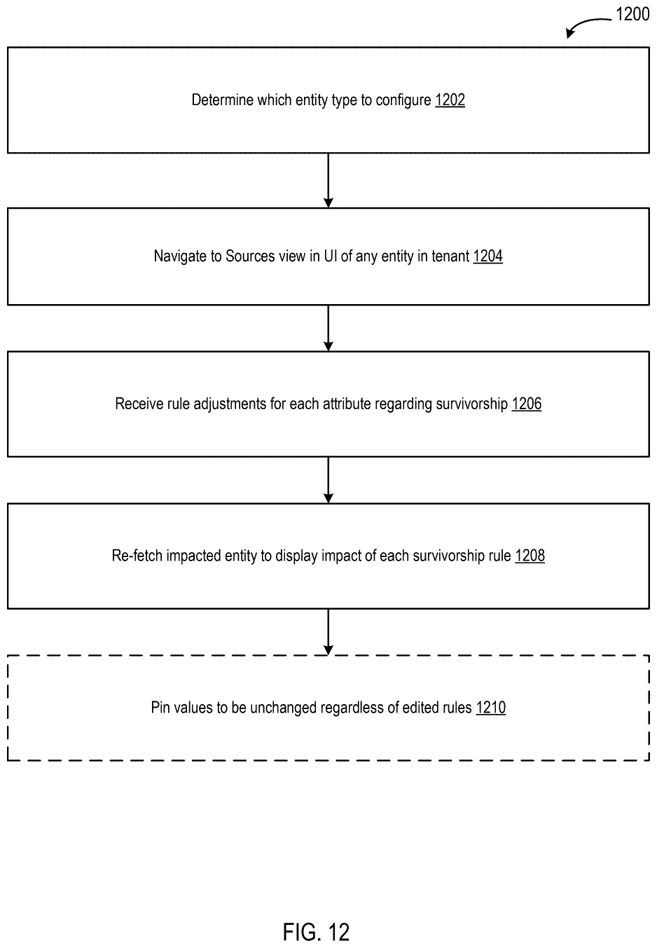

FIG. 12 depicts a flowchart for configuring survivorship within an example UI in some embodiments. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

When configuring survivorship via the UI, the user may not use the UI Modeler or Data Modeler. To configure attribute value survivorship via the UI, in step 1202, the user may determine which entity type to configure, then they may navigate to the Sources view of any actual entity in the tenant in step 1420. It may not matter which entity that is selected but it is recommended that the user pick one that has been sufficiently merged and thus has enough crosswalks (and thus raw values in its attributes) so that the user may witness material effects on-the-fly as they modify the survivorship rules.

In step 1208, in the Sources view while editing the survivorship for each attribute, the user can instantly see the effect on the screen in step 1208, which may guide the user. After you make a rule adjustment, the entity is fetched again using your new version of the rule and so you see the effect instantaneously.

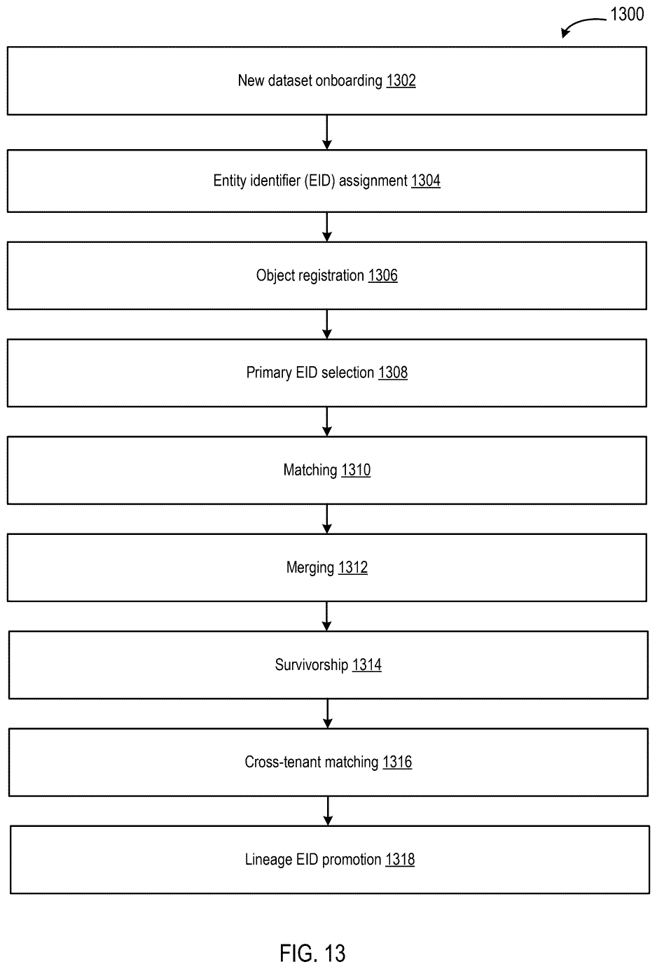

FIG. 13 depicts a flowchart of an example of a method of cross-tenant matching and lineage EID promotion. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

The flowchart 1300 starts at module 1302 with new dataset onboarding. New dataset onboarding is described above with reference to a dataset onboarding engine, which can carry out the process. Like the other engines described herein, the dataset onboarding engine may be a component of one or more regional platform instances.

The flowchart 1300 continues to module 1304 with EID assignment. EID assignment can be performed using an EID assignment engine. Like the other engines described herein, the EID assignment engine may be a component of one or more regional platform instances.

The flowchart 1300 continues to module 1306 with object registration. Object registration can be performed by an object registration engine. Like the other engines described herein, the object registration engine may be a component of one or more regional platform instances.

The flowchart 1300 continues to module 1308 with primary EID selection. Primary EID selection would occur naturally for a new object that has only one EID, but for objects that are merged, a primary EID is selected. A primary EID selection engine can carry out the process. Like the other engines described herein, the primary EID selection engine may be a component of one or more regional platform instances.

The flowchart 1300 continues to module 1310 with matching. Matching refers to the matching of objects in a datastore, such tenant datastores and/other datastores or systems. Because of a continuous process of integrating objects into the datastore(s), at some point an attempt at matching is likely to be made for every object that is onboarded, which may or may not result in a match. A matching engine can carry out the process. Like the other engines described herein, the matching engine may be a component of one or more regional platform instances.

The flowchart 1300 continues to module 1312 with merging. Merging refers to finding two objects that represent a common real world entity. A merging engine can carry out the process. Not all objects that are onboarded will necessarily be merged with other objects. Accordingly, the module 1312 could be skipped. Like the other engines described herein, the merging engine may be a component of one or more regional platform instances.

The flowchart 1300 continues to module 1314 with survivorship. Survivorship refers to, among other things, the technique of persisting EIDs. A survivorship engine can carry out the process. Not all objects that are onboarded will necessarily be merged, thereby triggering the survivorship, so the module 1314 could be skipped. Like the other engines described herein, the survivorship engine may be a component of one or more regional platform instances.

The flowchart 1300 continues to module 1316 with cross-tenant matching. Cross-tenant matching refers to the ability of a first tenant to use a first EID (or agent of the cross-tenant durable EID lineage-persistent RDBMS or other party that is given access) to match an object with a second EID at a second tenant. A cross-tenant matching engine, which can carry out the process, in part, by recognizing objects in two different tenants are associated with the same real world entity. It is not necessary for there to be actual cross-tenant matching for the flowchart 1300 to continue to module 1318. Like the other engines described herein, the cross-tenant matching engine may be a component of one or more regional platform instances.

The flowchart 1300 ends at module 1318 with lineage EID promotion. For example, a lineage EID promotion engine, which can carry out the process, in part, by persisting lineage EIDs and enables unmerging of objects in real time, without taking a datastore of the cross-tenant durable EID lineage-persistent RDBMS offline, at which point the flowchart 1300 can resume at one of several of the modules 1302-1318. Like the other engines described herein, the lineage EID promotion engine may be a component of one or more regional platform instances.

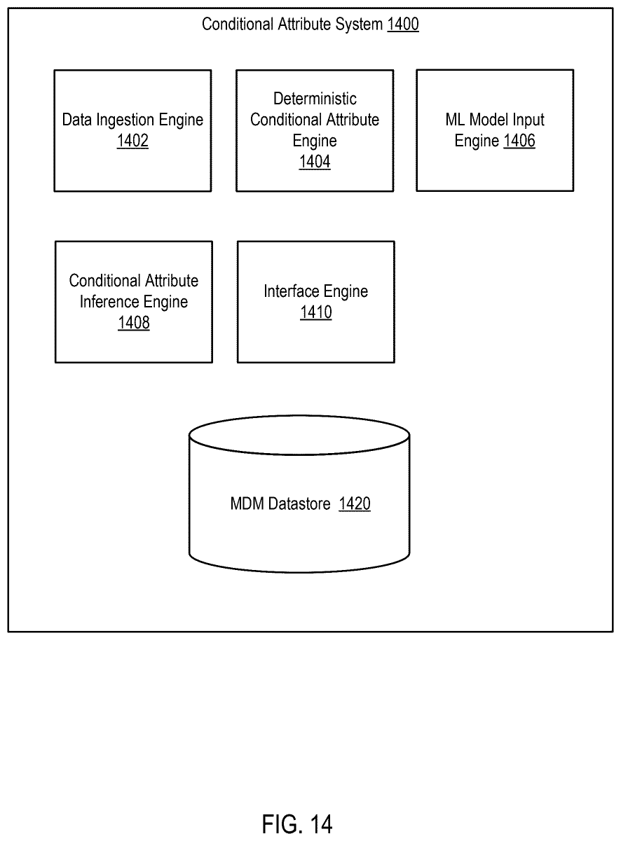

FIG. 14 depicts a diagram of an example of a conditional attribute system 1400. In the example of FIG. 14, the conditional attribute system 1400 includes a data ingestion engine 1402, a deterministic conditional attribute engine 1404, a machine learning model input engine 1406, a conditional attribute inference engine 1408, am interface engine 1410, and an MDM datastore 1420. In some embodiments, the conditional attribute system 1400 is part of the platform 102. In other embodiments, the conditional attribute system 1400 is distinct from the platform 102.

Generally, customers (e.g., tenants of the platform 102) often need flexibility in a data model. A single entity type can have different variations or subtypes where each has a unique set of attributes controlled by a condition. Without this flexibility in a data model, customers will have to create large numbers of entity types with overlapping attributes, making a solution complex and difficult to maintain, and/or receive sub-optimal user experiences and higher time-to-value.

Often the existence of a few entity attributes in a data model depend on the value of other attribute(s) from the same entity type. Because the visibility of these attributes is controlled by a condition, they are called conditional attributes. In a specific implementation, a data structure has “all” attributes (some of which may be null, unknown, inapplicable, etc.), a first subset of which can be generic (applicable to all data structures) and a second subset of which are conditional (e.g., shown or not shown depending upon values of the first subset of attributes or other considerations). Whether all data structures can actually have “all” attributes is implementation specific. In any case, which attributes are shown depends upon various factors, making a subset of “all” attributes conditional attributes that depend upon the entity type of the data structure.

Factors can be preconfigured and can include considerations of grouping (e.g., by entity type) and subgrouping (e.g., by entity subtype). For example, for a product entity type, a user may care if the product is dairy (first subgroup) or shelf-stable (second subgroup). For dairy, a user might care how long before it expires. There may also be different attributes if the product is a liquid versus a solid. For liquids, a user may care about fluid volume, but for solids, the user may care about weight. Thus, the attribution is based on categorization by group or subgroup. So, the user can set a dependency such that if the user chooses a value, the user is presented with what you will care about next.

Conceptually, a data structure could be characterized as belonging to more than one entity type or group. Entity types need not be “human-understandable” groups. For example, the system may group data in a manner that does not lend itself easily to a “handle” that a human would naturally use to refer to the entity type. The ability of a human to easily attach a handle to a hybrid entity type or specific subgroup can grow increasingly difficult as the system finds more ways to group data.

In a specific implementation, Machine Learning (ML) is used to form groups (and subgroups) and identify conditional attributes for the groups within an MDM datastore 1420. A conditional attribute inference engine 1208 infers what might be desired as a conditional attribute for a data structure. Inferences can be drawn from customer preferences, what other customers have done, knowledge of the domain, ISO standards for specific products around schema, or the like. In a specific implementation, mandatory and likely attributes are shown. It may be desirable to include an “interim” toggle that shows things that might be useful as opposed to probably useful. Advantageously, “inferring a data structure” or inferring based on data what is the right set of attributes means a customer need not do it explicitly (e.g., as part of data classification). For example, if a user keeps entering an attribute that was not part of an original data structure, the system can add it to the useful set without being explicitly told to do so.

In an example of a use-case, a user and/or system can pick (e.g., select) first, second, and third values in a first order, and the conditional attribute system 1400 can generate a first customizable data structure (or, dynamic data structure) and if the user picks first, second, and third values in a second order, the conditional attribute system 1400 can generate a second customizable data structure. For example, if someone is already a researcher and becomes a doctor, then that person might not be able to sell to me because that person knew me as a researcher first, which can be characterized as a conflict-of-interest category. Thus, this use-case is related to knowing individuals in both a first and second context (e.g., vendor and supplier) but needing to treat them differently based on the first context (e.g., if known as a vendor first, you can take them to lunch, but not if you knew them as a supplier first). It may be desirable for a data structure to have role-based attributes in case attribute is defined as personally identifiable information (PII).

The data ingestion engine 1402 is intended to represent an engine that ingests data from a variety of different data sources having a variety of different data formats. The data ingestion engine 1402 can ingest data across one or more communications networks (e.g., WAN, LAN, Internet, VPN, etc.). In some embodiments, the data ingestion engine 1402 may normalize ingested data (e.g., using one or more normalization functions). Ingested data can include rows, columns, arrays, and/or other structures and formats.

The deterministic conditional attribute engine 1404 is intended to represent an engine that defines a plurality of deterministic conditional attribute rules (or, simply, “rules”). The rules may specify dependencies between entity attributes of a set of entity attributes. At least a portion of the entity attributes may include conditional entity attributes, and the conditional entity attributes depend on the values of one or more of the other entity attributes of the set of the entity attributes. In some embodiments, the deterministic conditional attribute engine 1404 can function to define a data model based on the plurality of deterministic conditional attribute rules and the one or more entity types.

In some embodiments, the deterministic conditional attribute engine 1404 can function to determine an order of the entity attributes and associated attribute values, and also define a data model based on the plurality of deterministic conditional attribute rules and the order of the entity attributes and associated attribute values. The deterministic conditional attribute engine 1404 may also receive and/or generate query responses. For example, the deterministic conditional attribute engine 1404 can generate query responses based on the data model defined based on the plurality of deterministic conditional attribute rules and the order of the entity attributes and associated attribute values.

The machine learning model input engine 1406 is intended to represent an engine that generates a machine learning model input. For example, the machine learning model input engine 1406 can generate machine learning model inputs based on ingested data.

The conditional attribute inference engine 1408 is intended to represent an engine that infers (or, predicts), using one or more machine learning models, an inferred dynamic data structure (or, inferred dynamic data model). The inferred dynamic data structure may include a subset of entity attributes inferred by the machine learning model from a set of the entity attributes. At least a portion of the entity attributes may include conditional entity attributes, and the conditional entity attributes depend on the values of one or more of the other entity attributes of the set of the entity attributes.

In some embodiments, the conditional attribute inference engine 1408 can function to track user interactions received through the GUI associated with the visual representation of the inferred dynamic data structure. In some embodiments, the conditional attribute inference engine 1408 can function to dynamically adjust, using one or more machine learning models, the inferred dynamic data structure based on the tracked user interactions.

The interface engine 1410 is intended to represent an engine that presents visual, audio, and/or haptic information. In some implementations, the interface engine 1410 generates graphical user interface components (e.g., server-side graphical user interface components) that can be rendered as complete graphical user interfaces on various systems (e.g., client systems). The interface engine 1410 can function to present an interactive graphical user interface for display and receiving information.

In some embodiments, the interface engine 1410 may facilitate cooperation between systems. For example, the interface engine 1410 may facilitate cooperation between the automated data classification system 600 and the conditional attribute system 1400.

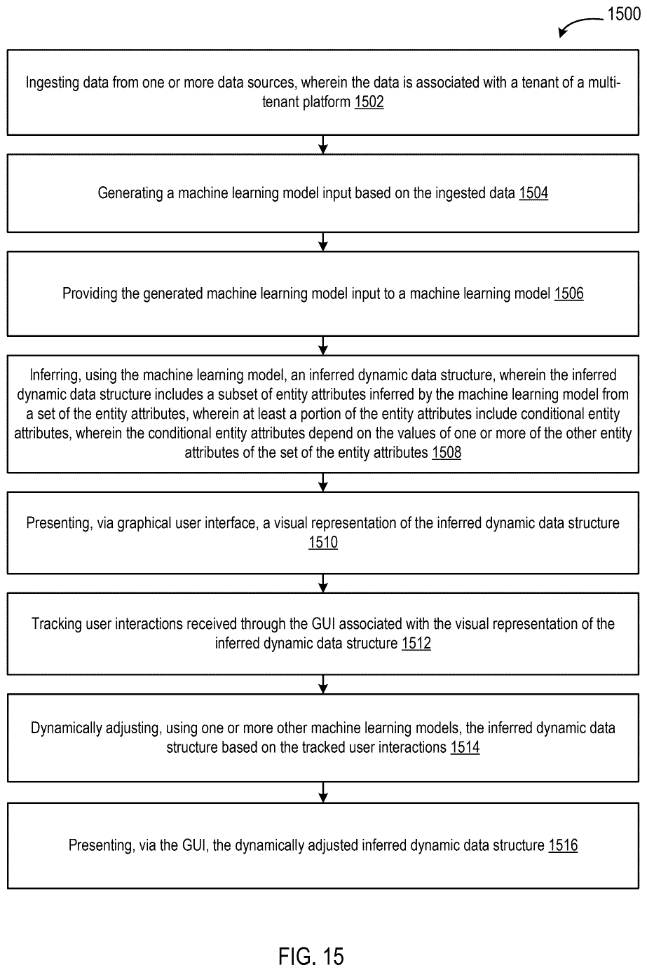

FIG. 15 depicts a flowchart 1500 of an example method of inferring dynamic data structures (or, data models) and generating graphical user interfaces (GUIs) based on the inferred dynamic data structures. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

In module 1502, a computing system (e.g., conditional attribute system 1400) ingests data from one or more data sources. The data may be associated with a tenant of a multi-tenant platform. In some embodiments, a data ingestion engine (e.g., data ingestion engine 1402) ingests the data.

In module 1504, the computing system generates a machine learning model input based on the ingested data. In some embodiments, a machine learning model input engine (e.g., machine learning model input engine 1406) generates the machine learning model input.

In module 1506, the computing system provides the generated machine learning model input to a machine learning model. In some embodiments, the machine learning model input engine provides the input to the machine learning model.

In module 1508, the computing system infers, using the machine learning model, an inferred dynamic data structure. The inferred dynamic data structure may include a subset of entity attributes inferred by the machine learning model from a set of the entity attributes. At least a portion of the entity attributes may include conditional entity attributes, and the conditional entity attributes may depend on the values of one or more of the other entity attributes of the set of the entity attributes. In some embodiments, a conditional attribute inference engine (e.g., conditional attribute inference engine 1408) infers the dynamic data structure. In some embodiments, the inferences comprises predicting a dynamic data structure.

In module 1510, the computing system presents, via a graphical user interface (GUI), a visual representation of the inferred dynamic data structure. In some embodiments, an interface engine (e.g., interface engine 1410) presents the visual representation.

In module 1512, the computing system tracks user interactions received through the GUI associated with the visual representation of the inferred dynamic data structure. In some embodiments, the interface engine and/or the conditional attribute inference engine tracks the user interactions.

In module 1514, the computing system dynamically adjusts, using one or more other machine learning models, the inferred dynamic data structure based on the tracked user interactions. In some embodiments, the conditional attribute inference engine adjusts the inferred dynamic data structure.

In module 1516, the computing system presents, via the GUI, the dynamically adjusted inferred dynamic data structure. In some embodiments, the interface engine present the dynamically adjusted inferred dynamic data structure.

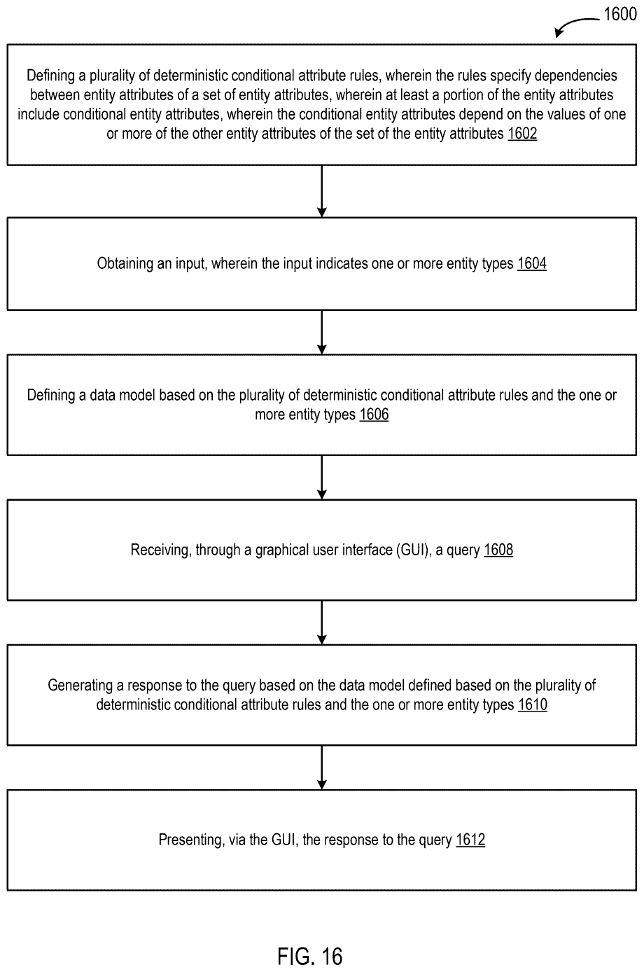

FIG. 16 depicts a flowchart 1600 of an example method of defining a data model (or, data structure) based on deterministic conditional attribute rules, and generating a response to a query based on the data model. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

In module 1602, a computing system (e.g., conditional attribute system 1400) defines a plurality of deterministic conditional attribute rules. The rules may specify dependencies between entity attributes of a set of entity attributes, and at least a portion of the entity attributes may include conditional entity attributes. The conditional entity attributes may depend on the values of one or more of the other entity attributes of the set of the entity attributes. In some embodiments, a deterministic conditional attribute engine (e.g., deterministic conditional attribute engine 1404) defines the rules.

In module 1604, the computing system obtains an input. The input may indicate one or more entity types. The input may be human-readable and/or machine-readable. In some embodiments, an interface engine (e.g., interface engine 1410) obtains the input (e.g., from a user and/or system).

In module 1606, the computing system defines a data model based on the plurality of deterministic conditional attribute rules and the one or more entity types. In some embodiments, deterministic conditional attribute engine defines the data model. The data model may be a data structure.

In module 1608, the computing system receives, through a graphical user interface (GUI), a query. In some embodiments, the interface engine receives the query (e.g., from a user and/or system). In some embodiments, another computing system (e.g., the platform 102 and/or client system) receives the query in module 1608 and/or generates the response in module 1610.

In module 1610, the computing system generates a response to the query based on the data model defined based on the plurality of deterministic conditional attribute rules and the one or more entity types. In some embodiments, another computing system (e.g., the platform 102 and/or client system) generates the response to the query.

In module 1612, the computing system presents, via the GUI, the response to the query. In some embodiments, the interface engine presents the response. In some embodiments, another computing system (e.g., the platform 102 and/or client system) presents the response to the query (e.g., to a user associated with a tenant of the multi-tenant platform).

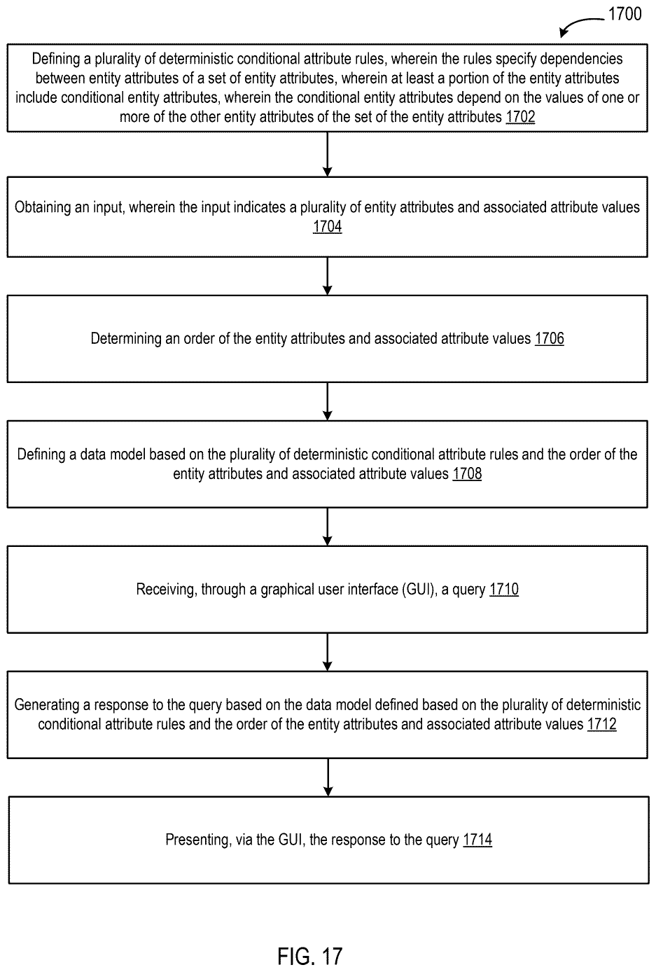

FIG. 17 depicts a flowchart 1700 of an example method of defining a data model (or, data structure) based on deterministic conditional attribute rules and an order of entity attributes and associated values. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

In module 1702, a computing system (e.g., conditional attribute system 1400) defines a plurality of deterministic conditional attribute rules. The rules may specify dependencies between entity attributes of a set of entity attributes. At least a portion of the entity attributes may include conditional entity attributes, and the conditional entity attributes may depend on the values of one or more of the other entity attributes of the set of the entity attributes. In some embodiments, a deterministic conditional attribute engine (deterministic conditional attribute engine 1404) defines the rules.

In module 1704, the computing system (e.g., conditional attribute system 1400) obtains an input. The input may indicate a plurality of entity attributes and associated attribute values. In some embodiments, an interface engine (e.g., interface engine 1410) obtains the input.

In module 1706, the computing system determines an order of the entity attributes and associated attribute values. In some embodiments, a conditional attribute inference engine (e.g., conditional attribute inference engine 1408) determines the order.

In module 1708, the computing system defines a data model based on the plurality of deterministic conditional attribute rules and the order of the entity attributes and associated attribute values. In some embodiments, a deterministic conditional attribute engine (e.g., deterministic conditional attribute engine 1404) defines the data model).

In module 1710, the computing system receives, through a graphical user interface (GUI), a query. In some embodiments, an interface engine (e.g., interface engine 1410) receives the query).

In module 1712, the computing system generates a response to the query based on the data model defined based on the plurality of deterministic conditional attribute rules and the order of the entity attributes and associated attribute values. In some embodiments, the deterministic conditional attribute engine generates the response.

In module 1714, the computing system presents, via the GUI, the response to the query. In some embodiments, the interface engine presents the response.

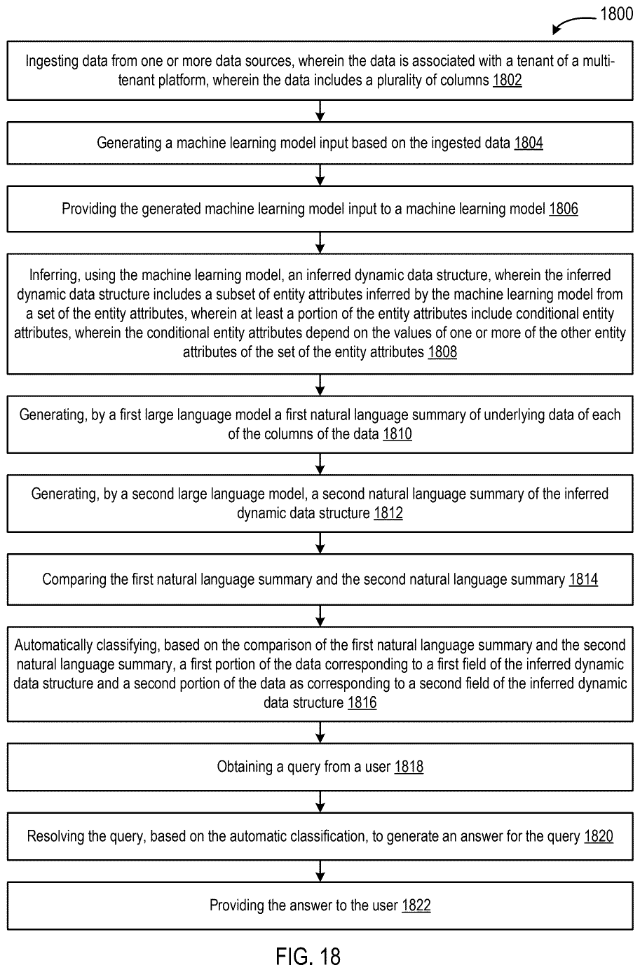

FIG. 18 depicts a flowchart 1800 of an example method of using dynamic data structure (or, data model) inference and automated data classification to resolve a query. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

In module 1802, a first computing system (e.g., conditional attribute system 1400) ingests data from one or more data sources. The data may be associated with a tenant of a multi-tenant platform, wherein the data includes a plurality of columns. In some embodiments, a data ingestion engine (e.g., data ingestion engine 1402) ingests the data.

In module 1804, the first computing system generates a machine learning model input based on the ingested data. In some embodiments, a machine learning model input engine (e.g., machine learning model input engine 1406) generates the machine learning model input.

In module 1806, the first computing system provides the generated machine learning model input to a machine learning model. In some embodiments, the machine learning model input engine provide the machine learning model input to the machine learning model.

In module 1808, the first computing system infers, using the machine learning model, an inferred dynamic data structure (or, inferred dynamic data model). The inferred dynamic data structure may include a subset of entity attributes inferred by the machine learning model from a set of the entity attributes. At least a portion of the entity attributes may include conditional entity attributes, and the conditional entity attributes may depend on the values of one or more of the other entity attributes of the set of the entity attributes. In some embodiments, a conditional attribute inference engine (e.g., conditional attribute inference engine 1408) infers the dynamic data structure.

In module 1810, a second computing system (e.g., automated data classification system 600) generates, by a first large language model a first natural language summary of underlying data of each of the columns of the data. In some embodiments, a data summarization engine (e.g., data summarization engine 604) generates the first natural language summary.

In module 1812, the second computing system generates, by a second large language model, a second natural language summary of the inferred dynamic data structure. In some embodiments, a data model summarization engine (e.g., data model summarization engine 606) generates the second natural language summary.

In module 1814, the second computing system compares the first natural language summary and the second natural language summary. In some embodiments, a summarization comparison engine (e.g., summarization comparison engine 608) performs the comparison.

In module 1816, the second computing system automatically classifies, based on the comparison of the first natural language summary and the second natural language summary, a first portion of the data corresponding to a first field of the inferred dynamic data structure and a second portion of the data corresponding to a second field of the inferred dynamic data structure. In some embodiments, a mapping engine (e.g., mapping engine 610) performs the automatic classification.

In module 1818, the second computing system obtains a query from a user. In some embodiments, an interface engine (e.g., interface engine 612) obtains the query. In some embodiments, another computing system obtains the query (e.g., platform 102).

In module 1820, the second computing system resolves the query, based on the automatic classification, to generate an answer for the query. In some embodiments, another computing (e.g., platform 102) system resolves the query.

In module 1822, the second computing system provides the answer to the user. In some embodiments, another computing system (e.g., platform 102) provides the answer to user.

1. A system comprising:
one or more processors; and
memory storing instructions that, when executed by the one or more processors, cause the system to perform:
ingesting data from one or more data sources;
generating a machine learning model input based on the ingested data;
providing the generated machine learning model input to a machine learning model;
inferring, using the machine learning model, an inferred dynamic data structure, wherein the inferred dynamic data structure includes a subset of entity attributes inferred by the machine learning model from a set of the entity attributes, wherein at least a portion of the entity attributes include conditional entity attributes, wherein the conditional entity attributes depend on values of one or more of the other entity attributes of the set of the entity attributes;
presenting, via a graphical user interface (GUI), a visual representation of the inferred dynamic data structure;
tracking user interactions received through the GUI associated with the visual representation of the inferred dynamic data structure;
dynamically adjusting, using one or more other machine learning models, the inferred dynamic data structure based on the tracked user interactions;
presenting, via the GUI, the dynamically adjusted inferred dynamic data structure.

2. The system of claim 1, wherein the data is associated with a tenant of a multi-tenant platform.

3. The system of claim 2, wherein the inferred dynamic data structure comprises an inferred dynamic data model.

4. The system of claim 2, wherein inferring the inferred dynamic data structure comprises predicting the inferred dynamic data structure.

5. The system of claim 2, wherein the conditional entity attributes comprise entity attributes whose visibility is controlled by one or more conditions.

6. A method comprising:
ingesting data from one or more data sources;
generating a machine learning model input based on the ingested data;
providing the generated machine learning model input to a machine learning model;
inferring, using the machine learning model, an inferred dynamic data structure, wherein the inferred dynamic data structure includes a subset of entity attributes inferred by the machine learning model from a set of the entity attributes, wherein at least a portion of the entity attributes include conditional entity attributes, wherein the conditional entity attributes depend on the values of one or more of the other entity attributes of the set of the entity attributes;
presenting, via a graphical user interface (GUI), a visual representation of the inferred dynamic data structure;
tracking user interactions received through the GUI associated with the visual representation of the inferred dynamic data structure;
dynamically adjusting, using one or more other machine learning models, the inferred dynamic data structure based on the tracked user interactions;
presenting, via the GUI, the dynamically adjusted inferred dynamic data structure.

7. The method of claim 6, wherein the data is associated with a tenant of a multi-tenant platform.

8. The method of claim 7, wherein the inferred dynamic data structure comprises an inferred dynamic data model.

9. The method of claim 7, wherein inferring the inferred dynamic data structure comprises predicting the inferred dynamic data structure.

10. The method of claim 7, wherein the conditional entity attributes comprise entity attributes whose visibility is controlled by one or more conditions.

11. A system comprising:
one or more processors; and
memory storing instructions that, when executed by the one or more processors, cause the system to perform:
defining a plurality of deterministic conditional attribute rules, wherein the rules specify dependencies between entity attributes of a set of entity attributes, wherein at least a portion of the entity attributes include conditional entity attributes, wherein the conditional entity attributes depend on values of one or more of the other entity attributes of the set of the entity attributes;
obtaining an input, wherein the input indicates one or more entity types;
defining a data model based on the plurality of deterministic conditional attribute rules and the one or more entity types;
receiving, through a graphical user interface (GUI), a query;
generating a response to the query based on the data model defined based on the plurality of deterministic conditional attribute rules and the one or more entity types;
presenting, via the GUI, the response to the query.

12. The system of claim 11, wherein the conditional entity attributes comprise entity attributes whose visibility is controlled by one or more conditions.

13. The system of claim 12, wherein an entity type includes a class of entity.

14. The system of claim 12, wherein the one or more entity types include one of an individual entity, an organization entity, a location entity, and a product entity.

15. A method comprising:
defining a plurality of deterministic conditional attribute rules, wherein the rules specify dependencies between entity attributes of a set of entity attributes, wherein at least a portion of the entity attributes include conditional entity attributes, wherein the conditional entity attributes depend on values of one or more of the other entity attributes of the set of the entity attributes;
obtaining an input, wherein the input indicates one or more entity types;
defining a data model based on the plurality of deterministic conditional attribute rules and the one or more entity types;
receiving, through a graphical user interface (GUI), a query;
generating a response to the query based on the data model defined based on the plurality of deterministic conditional attribute rules and the one or more entity types;
presenting, via the GUI, the response to the query.

16. The method of claim 15, wherein the conditional entity attributes comprise entity attributes whose visibility is controlled by one or more conditions.

17. The method of claim 16, wherein an entity type includes a class of entity.

18. The method of claim 16, wherein the one or more entity types include one of an individual entity, an organization entity, a location entity, and a product entity.

19. A system comprising:
one or more processors; and
memory storing instructions that, when executed by the one or more processors, cause the system to perform:
defining a plurality of deterministic conditional attribute rules, wherein the rules specify dependencies between entity attributes of a set of entity attributes, wherein at least a portion of the entity attributes include conditional entity attributes, wherein the conditional entity attributes depend on the values of one or more of the other entity attributes of the set of the entity attributes;
obtaining an input, wherein the input indicates a plurality of entity attributes and associated attribute values;
determining an order of the entity attributes and associated attribute values;
defining a data model based on the plurality of deterministic conditional attribute rules and the order of the entity attributes and associated attribute values;
receiving, through a graphical user interface (GUI), a query;
generating a response to the query based on the data model defined based on the plurality of deterministic conditional attribute rules and the order of the entity attributes and associated attribute values;
presenting, via the GUI, the response to the query.

20. A method comprising:
defining a plurality of deterministic conditional attribute rules, wherein the rules specify dependencies between entity attributes of a set of entity attributes, wherein at least a portion of the entity attributes include conditional entity attributes, wherein the conditional entity attributes depend on values of one or more of the other entity attributes of the set of the entity attributes;
obtaining an input, wherein the input indicates a plurality of entity attributes and associated attribute values;
determining an order of the entity attributes and associated attribute values;
defining a data model based on the plurality of deterministic conditional attribute rules and the order of the entity attributes and associated attribute values;
receiving, through a graphical user interface (GUI), a query;
generating a response to the query based on the data model defined based on the plurality of deterministic conditional attribute rules and the order of the entity attributes and associated attribute values;
presenting, via the GUI, the response to the query.

21. A system comprising:
one or more processors; and
memory storing instructions that, when executed by the one or more processors, cause the system to perform:
ingesting data from one or more data sources, wherein the data is associated with a tenant of a multi-tenant platform, wherein the data includes a plurality of columns;
generating a machine learning model input based on the ingested data;
providing the generated machine learning model input to a machine learning model;
inferring, using the machine learning model, an inferred dynamic data structure, wherein the inferred dynamic data structure includes a subset of entity attributes inferred by the machine learning model from a set of the entity attributes, wherein at least a portion of the entity attributes include conditional entity attributes, wherein the conditional entity attributes depend on values of one or more of the other entity attributes of the set of the entity attributes;
generating, by a first large language model, a first natural language summary of underlying data of each of the columns of the data;
generating, by a second large language model, a second natural language summary of the inferred dynamic data structure;
comparing the first natural language summary and the second natural language summary;
automatically classifying, based on the comparison of the first natural language summary and the second natural language summary, a first portion of the data as corresponding to a first field of the inferred dynamic data structure and a second portion of the data as corresponding to a second field of the inferred dynamic data structure;
obtaining a query from a user;
resolving the query, based on the automatic classification, to generate an answer for the query;
providing the answer to the user.
